(19) United States
(12) Patent Application Publication
(10) Pub. No.: US 2013/0304530 A1
(43) Pub. Date: Nov. 14, 2013

(54) AUTOMATED GENERATION OF PROCESS MONITORING SYSTEM COMPONENTS

(71) Applicants: Prasad A. Chodavarapu, Bangalore (IN); Subramaniam Turuvekere, Bangalore (IN)

(72) Inventors: Prasad A. Chodavarapu, Bangalore (IN); Subramaniam Turuvekere, Bangalore (IN)

(21) Appl. No.: 13/467,282

(22) Filed: May 9, 2012

(51) Int. Cl. G06Q 10/00

(52) U.S. Cl. 705/7.11

(57) ABSTRACT

Systems and methods provide automatic configuration of a process monitoring system to monitor some or all business activity in a business process. Structured business process information that defines the business process is accessed and parsed, to automatically generate one or more process monitoring components to form part of the process monitoring system. The process monitoring system monitors events with respect to a plurality of unmanaged enterprise applications that perform business process activities. The unmanaged enterprise applications perform the process activities without central orchestration by a business process management application.

### BACKGROUND

To obtain real-time information about the status and results of various activities that form part of a business process, business activity monitoring (BAM) systems may be employed. BAM provides real-time monitoring of business metrics, and may include notification and correction processes that are initiated when problems arise.

Such BAM systems often depend on orchestration of the underlying processes and/or applications, for example by a business process management system (BPMS). In such instances, process activities performed by respective enterprise applications are modeled in the BPMS and are, at least to some extent, orchestrated under control of the BPMS.

As used herein “orchestration” means coordination of operations performed by two or more separate enterprise applications by a common automated coordinator, often a BPMS, and is thus also referred to as “central orchestration.” Such coordination involves more than monitoring or information collection from the enterprise applications, and comprises at least some control over the enterprise applications, so that at least some aspects (e.g., synchronization) of performance of the operations by the enterprise applications are affected by the orchestration.

Business process elements that are not subject to such central orchestration are referred to herein as being “unorchestrated,” while enterprise applications that are not subject to central orchestration are referred to herein both as “unmanaged applications,” or “unorchestrated applications.”

Dependence of business activity monitoring on a business process management solution and/or a business process management orchestration layer often involves changes in how processes are carried out by humans and/or extensive integration of BPMS with enterprise applications, especially legacy applications, before a business application monitoring solution can be employed.

### BRIEF DESCRIPTION OF THE DRAWINGS

Some embodiments are illustrated by way of example and not limitation in the figures of the accompanying drawings. In the drawings, like reference numerals indicate like elements.

FIG. 1 is a schematic functional diagram of an example embodiment of a process monitoring system and a process monitoring configuration system to configure the process monitoring system, including automatic generation of at least some components of the process monitoring system.

FIG. 2 is another schematic functional diagram of an example embodiment of a process monitoring system in accordance with FIG. 1.

FIG. 3 is a high-level schematic block diagram of a process monitoring configuration system, in accordance with another example embodiment.

FIG. 4 is a schematic block diagram of an environment in which a process monitoring system and a process monitoring configuration system may be provided, in accordance with another example embodiment.

FIG. 5 is a schematic block diagram of process monitoring application(s) forming part of the example embodiment of a process monitoring and monitoring configuration system.

FIG. 6 is a schematic diagram of a data structure for business process information and enterprise architecture information that may form part of a process modeling system in accordance with an example embodiment.

FIGS. 7A-7D is a schematic view of some logical process model information forming part of business process model information in accordance with an example embodiment.

FIG. 8 is a high-level schematic flow chart of a method of configuring a process monitoring system, in accordance with an example embodiment.

FIG. 9 is a schematic flow chart illustrating a more detailed example embodiment of a method of configuring a process monitoring system and of a method of monitoring a business process.

FIG. 10 is a schematic view of an example process that is to be monitored by a process monitoring system in accordance with an example embodiment.

FIGS. 11A-11B show example monitoring components in the example form of respective blocks of code generated by a process monitoring configuration system, in accordance with an example embodiment.

FIG. 12 is an example graphic user interface to display potential correlations between process failures and IT system failures, in accordance with an example embodiment.

FIGS. 13A-13C are example monitoring dashboard displays generated by a process monitoring system, in accordance with an example embodiment.

FIG. 14 is a diagrammatic representation of a machine in the example form of a computer system within which a set of instructions for causing the machine to perform any one or more of the methodologies discussed herein may be executed.

### DETAILED DESCRIPTION

Example methods and systems to monitor a business process and/or to configure a business process monitoring system will now be described. In the following description, for purposes of explanation, numerous specific details are set forth in order to provide a thorough understanding of example embodiments. It will be evident, however, to one of ordinary skill in the art that many other embodiments that fall within the scope of the present disclosure may be practiced without these specific details.

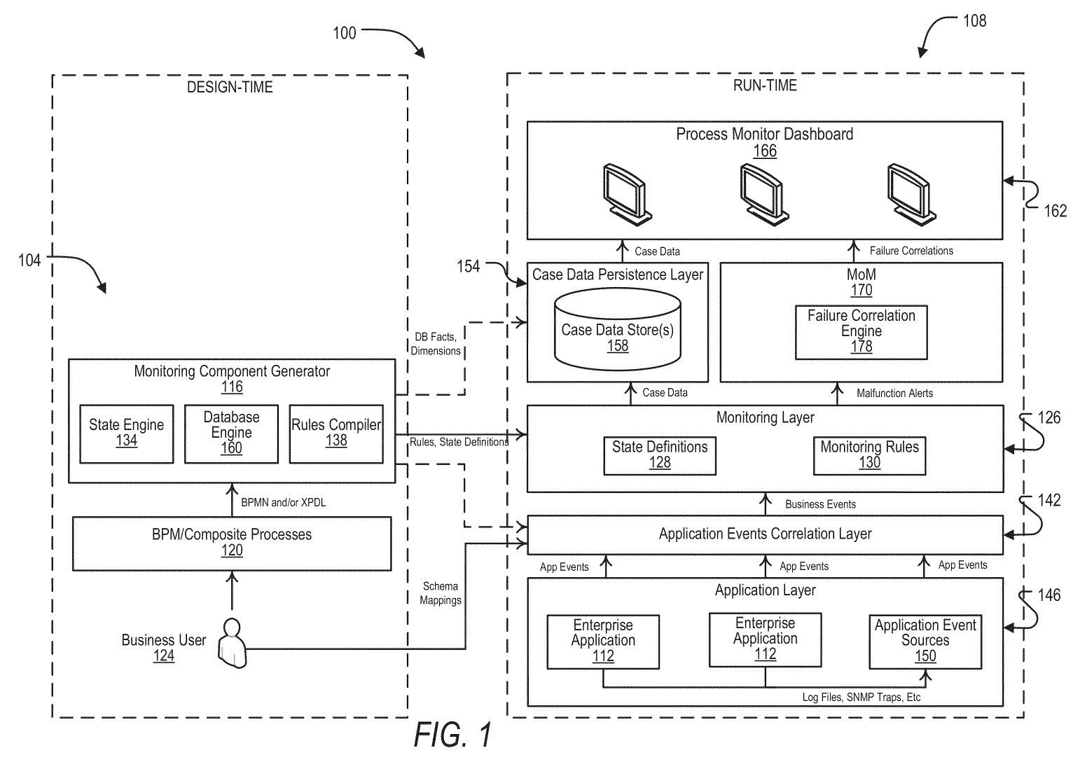

FIG. 1 is a high-level functional diagram of an example embodiment of a system 100 that comprises a process monitoring system 108 to monitor a business process and/or business activities without requiring orchestration of monitored enterprise applications 112 by a business process management system, and a process monitoring configuration system 104 to configure and/or compile the process monitoring system 108 by automatically generating at least some monitoring components of the monitoring system 108.

The configuration system 104 includes a monitoring component generator 116 to automatically generate monitoring components for incorporation in the monitoring system 108. The example monitoring system 108 may include a central monitoring layer 126 that receives business event information regarding business events indicated by monitored activity in the enterprise applications 112, to monitor performance of individual instances or cases of a monitored business process with reference to process state definitions 128 and process monitoring rules 130 included in the monitoring layer 126. A process state may, for example, comprise information regarding the most recent activity that was completed within the process, the time at which that event happened, process specific business data such as transaction identifiers, transaction quantities/values, timestamps and the like. Process state definitions 128 may define multiple distinct states for a particular process, may define a data structure and/or data fields to be associated with respective states, and may define relationships between states. Structured business process information that defines a business process may thus be monitored by defining various process states that respectively correspond to one or more process activities. Note that, in other embodiments, the business process may be encoded in the system 100 in a form other than by monitoring process states, for example by tracking performance of defined process activities.

The monitoring rules 130 may define particular parameters or indicators of the process that are to be measured and recorded, such as key performance indicators (KPIs), service level agreement (SLA) information, criteria for identifying nonperformance of process activities or for tracking nonoccurrence of process events, rules for raising process malfunction alerts or process incident tickets, business process rules defined by the user 124 to aggregate, analyze, and/or filter business events, and the like.

Note that the terms application event, business event, and IT event, as used herein, refer to separate concepts. In general, events are occurrences that happen at particular points in time and that may be relevant to a modeled process. The respective types of events described herein, however, occur in conceptually different process layers. Application events indicate particular operations and/or processes performed by respective enterprise applications 112, and may include the outputs and/or log information of process activities performed by the enterprise applications 112. Application events may thus be indicated by log files, simple network management protocol (SNMP) traps, etc. Business events, on the other hand, are occurrences at a conceptual process level of a business process, such as the performance of an activity in a sequence of activities that constitute the process. Considering, by way of analogy, a wedding, strict observance of physical phenomena or occurrences may register multiple events (analogous to application events) of, e.g., church bells ringing, the appearance of a man in a tuxedo together with a woman in wedding dress, and confetti being thrown, in a common location at more or less the same time. From these events may be inferred the occurrence of a higher-level event, namely the wedding (analogous to business events). If, in addition, information contained in a program distributed at the venue, in a church registry, and/or in a wedding registry (analogous to application events or application event information) is considered, the identity of the parties to the wedding may be inferred (analogous to inferring a particular case or process instance to which the business event applies). Similarly, the system 100 may be operable to identify business events by monitoring application events and, in an automated manner, mapping the application events to one or more business events according to predefined relationships between business events and underlying application events.

Yet further, IT events are concerned with the technical configuration and operation of respective components of an IT system. For example, malfunctioning of a server or of an enterprise application 112 will be an IT event that is reflected in IT event information, but is not considered an application event, as used herein.

In the example embodiment of FIG. 1, the monitoring component generator 116 is configured to automatically generate the state definitions 128 and the monitoring rules 130 based at least in part on business process information in the example form of the results of composite process analysis or a business process model (BPM) 120. These may be provided to the monitoring component generator 116 by a business user 124 via a user input device (not shown). In some embodiments, the business user 124 may provide a previously generated business process model in a standard notation such as Business Process Model and Notation (BPMN) and/or XML Process Definition Language (XPDL). Instead, or in addition, best-guess process models for existing business processes distributed across various unorchestrated enterprise applications 112 may be generated from business process analysis (BPA) tools.

In order to automatically generate the monitoring components, the business process information accessed by the monitoring component generator 116 may in some embodiments include one or more event models that model process events and describe associations between process events, such as the particular process activity with which the event is associated, the particular application or source that generates the event, and/or the business payload of the event, such as business identifiers, business date times, and business quantities.

The monitoring component generator 116 may parse the process model information and/or the event model information with which it is provided, and may generate monitoring components for the various layers of the monitoring system 108.

The monitoring system 108 may further include an event mining layer in the example form of an application events correlation layer 142 that receives application event information regarding application events occurring in an application layer 146 in which the enterprise applications function, to map the application event information to the business event information, and to pass the business event information to the monitoring layer 126. The business event information may be provided to the monitoring layer 126 by the application events correlation layer 142 in a single, standard event schema with name value pairs. The standard event schema thus serves as a common event schema for all of the monitored enterprise applications 112. The common event schema may include case identifiers, entity identifiers, application identifiers, date and time fields, numeric fields, and the like.

Configuration of the monitoring system 108 may thus include configuring the application events correlation layer 142 with respective schema mappings for each of the monitored enterprise applications 112, to map the application events reported by the respective enterprise application 112 to the common event schema. In some embodiments, custom configuration of schema mappings in the application events correlation layer 142 may be the only component of the monitoring system 108 which is custom-configured by the business user 124, the remainder of the monitoring system 108 being configured automatically by the monitoring configuration system 104 based on the relevant business process information. In some embodiments, at least some aspects of the application events correlation layer 142 may automatically be generated or configured by the monitoring configuration system 104 based on precompiled event models.

Although the example embodiment of FIG. 1 shows only two enterprise applications 112, it will be appreciated that that the application layer may often comprise a large number of enterprise applications. The application layer 146 in this example embodiment also includes application event sources 150 that may serve to mine or extract application events from the enterprise applications 112. The application event sources 150 may, for example, include log files, simple network management protocol (SNMP) traps, etc.

Instead, or in addition, the enterprise applications 112 may be configured to generate and send application event information directly to the application events correlation layer 142. Although not shown in FIG. 1, the monitoring component generator 116 may in some embodiments generate monitoring agents that are deployed to the enterprise applications 112 to record and transmit application events to the application events correlation layer 142.

The enterprise applications 112 shown in the application layer 146 of FIG. 1 execute process activities that form part of the monitored business process, but these process activities are not orchestrated by a central coordinator, such as a business process management application, and do not form part of a business process management layer or a business process orchestration layer. Again, such applications are referred to herein as unmanaged enterprise applications or as unorchestrated enterprise applications. Unmanaged applications therefore lack orchestration of the process activities executed thereby, but the enterprise applications 112 may of course be subject to management by application of processes unrelated to the process of orchestration, such as network management applications, configuration management applications, or the like. In other embodiments, the application layer 146 may comprise a mix of managed and unmanaged applications, so that some of the enterprise applications 112 are subject to business process management orchestration, while one or more of the enterprise applications 112 are unmanaged applications.

The monitoring system 108 may further include a case data persistence layer 154 that includes a process monitoring database in the example form of a case data store(s) 158. In this example embodiment, the case data store(s) 158 is configured to function similarly to a data warehouse with facts and dimension tables. The monitoring component generator 116 may include a database engine 160 that automatically generates monitoring components in the form of database elements by which the case data store(s) 158 is customized or configured for the particular business process that is to be monitored. The database engine 160 may thus automatically generate or update, for example, process fact tables and/or activity fact tables along with dimensions when a new business process is to be monitored, and may deploy these facts and dimensions to the case data store(s) 158. Such automatic configuration of the case data persistence layer 154 may be performed based at least in part on the common event schema, so that the database facts that are auto-generated are based on, for example, the identifiers, date-time, and numeric fields in the common event schema. The schema and datastore configuration may allow for quick data retrieval and may include automatic inclusion of one or more performance indicators, such as KPIs, SLA compliance data, etc. In this example embodiment, the automatic configuration of the case data store(s) 158 allows for the storage of summary values for KPIs in the case data store(s) 158.

A presentation layer 162 may include a presentation application in the example form of a process monitor dashboard 166 that generates a visual display and/or report with respect to the monitored performance of the relevant business process. The dashboard 166 may be configured to automatically display the particular performance indicators and process/activity facts recorded in the case data store(s) 158, so that the process monitoring configuration system 104 automatically configures the presentation layer 162 based on the business process that is to be monitored. The presentation layer 162 may thus provide standard services for a standard set of KPIs. Instead, or in addition, different KPIs based on business needs can be modeled and are configured by the business user 124 via a user input device or interface (not shown).

The monitoring system 108 may also monitor not only application and business events, but also information technology (IT) events relating to the performance of IT infrastructure elements, such as servers, network connections, routers, applications, and the like. Such IT events may, for example, include hardware failures, such as failure of a communication link, malfunction of a server, or the like. The IT events may also include events relating to the performance or malperformance of the enterprise applications 112. Note that, as used herein, IT events generated with respect to a particular enterprise application 112 are distinct from application events, in that the IT events are with respect to the configuration and operational status of the enterprise application 112, while the application events are with respect to the particulars, e.g., the output, of process activities performed by the enterprise application 112.

IT events may be reported to a manager of managers (MoM) 170. In the example embodiment of FIG. 1, the monitoring layer 126 is configured to generate process malfunction alerts in the example form of process incident tickets indicating process failure, such as nonperformance of an expected process activity. The monitoring layer 126 is enabled to identify such process failures and/or by the automatically generated state definitions 128 and monitoring rules 130 based on the underlying business process information. At least some IT event alerts sent to the MoM 170 may be in the form of IT incident tickets that indicate respective IT infrastructure problems or incidents that are to be investigated.

The monitoring system 108 may therefore generate both process incident tickets and IT event information, and may include a failure correlation engine 178 to analyze the IT event information and process incident tickets or process IT event information (such as process incident tickets), to identify correlation between IT events and process failures. The failure correlation engine 178 may, for example, identify that failure of a particular datastore is associated with nonperformance of a particular process activity (e.g., generation of an invoice). In this example embodiment, the failure correlation engine 178 is located at the MoM 170, but it will be appreciated that different configurations are possible in other embodiments. Identified failure correlations may be communicated to the presentation layer 162, to display potential failure correlations to business users via a display device on which the process monitor dashboard 166 is generated.

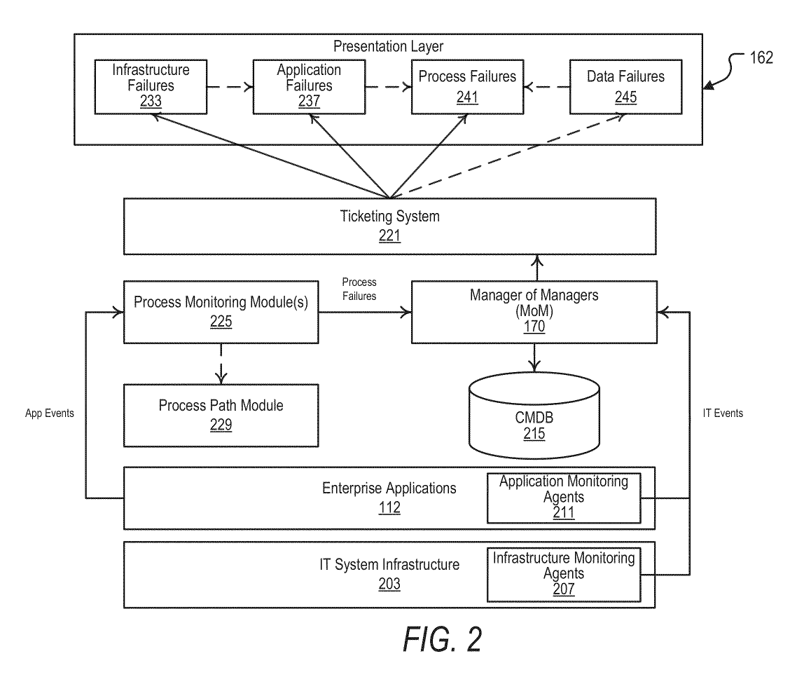

FIG. 2 illustrates a number of aspects of the monitoring system 108 that relate to monitoring IT events in combination with the monitoring of the application or process events. Thus, the figure schematically illustrates incorporation of infrastructure monitoring agents 207 in the IT system infrastructure 203 that supports the enterprise applications 112, as well as incorporation of application monitoring agents 211 in respective enterprise applications 112.

The application monitoring agents 211 and the infrastructure monitoring agents 207 are configured to send IT event information, in the example form of IT event alerts, to the MoM 170. The MoM 170 is responsible for correlation between business process incidents and IT incidents and to facilitate and/or enable this correlation, the MoM 170 is also in communication with a configuration management database (CMDB) 215 that stores configuration information with respect to the enterprise architecture that includes the dependencies between business processes 120, enterprise applications 112 and the IT system infrastructure 203.

Application events are communicated to a process monitoring module(s) 225 that is provided to perform part of the functionality of the monitoring layer 126 (see FIG. 1), to monitor performance of the business process by the unmanaged enterprise applications 112. Process monitoring is performed in part by a process path module 229 that is configured to predict and track the path of individual runtime cases in instances where one or more decision points exist within the monitoring process. In such instances, at runtime, a particular case can follow one of several possible decision paths, depending on the associated case data. For example, a process for increasing a credit limit in a banking environment may follow different paths depending on the status of the creditor, the size of the credit limit, the size of the credit increase, and so forth. As mentioned above, the monitoring system 108 makes provision for the incorporation of monitoring rules 130 that, inter alia, determine at runtime which corresponding activity needs to be checked or tracked (and, in some instances, anticipated) for SLA compliance, and may trigger an action on the appropriate activity.

The process monitoring module(s) 225 therefore identifies process failures based on predefined failure criteria that may be included in the monitoring rules 130, and communicates process failures to the MoM 170. Such process failures may comprise, for example, SLA violations, malperformance of process activities, or nonperformance of process activities.

In the example embodiment described with reference to FIG. 2, the MoM 170 communicates correlated IT failures and process failures to a ticketing system 221 that processes incident tickets and/or failures that occur in the enterprise IT system composed of the enterprise applications 112 and the IT system infrastructure 203. In some embodiments, process failure correlation may be performed by the MoM 170, while in other embodiments, the failure correlation may be performed by the ticketing system 221. The monitoring system 108 in this example generates process tickets with respect to process failures 241 in a manner similar to incident tickets generated with respect to IT system failures. IT system failures may include, for example: infrastructure failures 233 of IT infrastructure elements such as routers, servers, communication links, and the like; application failures 237 of applications (including the enterprise applications 112), for example when applications crash (e.g., by moving outside of established memory boundaries) or fail to execute; and data failures 245 that may occur with respect to data that is to be used in performance of the process activities by the enterprise applications 112. Examples of data failures 245 may include data synchronization failure, data corruption, usage of stale data, and the like.

As described with reference to FIG. 1, the monitoring system 108 may automatically correlate the various IT system failures to particular process failures, to identify potential relationships between the IT events and/or IT failures and corresponding process failures 241. Such failure correlations may be communicated to the business user 124 in the presentation layer 162, for example displaying a correlation report and/or graphs on a user endpoint device on which the process monitor dashboard 166 is provided. Based on identified correlation or association between particular IT failures or particular types of IT failures, the failure correlation engine 178 may assess or analyze the impact of IT failures on the monitored process and/or process activities, and may thereafter employ such identified associations to generate reports on business impact caused by IT incidents, such as IT outages. It may also generate recommendations and business case justifications for IT improvements needed for reducing business process failures.

To facilitate the identification of correlation and/or causation between IT failures and process failures, the failure correlation engine 178 may integrate with the enterprise architecture and process repositories or databases to analyze and determine links and associations between processes, process activities, enterprise applications 112, and IT system infrastructure 203. The monitoring system 108 may instead, or in addition, integrate with the CMDB 215 to determine asset details across processes, process activities, enterprise applications 112 and IT system infrastructure 203 elements.

The monitoring system 108 also integrates with the MoM 170 to generate process tickets in order to raise alerts with respect to process-related incidents in the same way that incident tickets are generated to raise alerts for infrastructure-related issues. Business processes are therefore treated similar to IT assets in the system 100.

One of the benefits of the example system 100 is that it provides business activity monitoring functionality, including parallel process path awareness and intelligence, while being independent of an underlying business process management system.

For example, implementation of the monitoring system 108, using the process monitoring configuration system 104, can reduce development cycle and rollout cost when compared to a comprehensive business process management solution. End-to-end business transactions can be monitored with process activities being performed in separate and distinct enterprise applications. Such end-to-end monitoring can be implemented without requiring change in the way processes are performed. Monitoring solution-driven process modifications may thus largely be avoided.

Business activity monitoring (BAM) solutions are often provided as an add-on to (or integrated feature of) a business process management/orchestration layer that orchestrates the flow of business activities and events that make up a business process, so that the use of business process management tools (such as a business process management system (BPMS)) is often a mandatory in order to implement a business activity monitoring solution. With a BPMS orchestration layer as a mandatory dependency, effective process monitoring in accordance with existing tools is unavailable in processes not orchestrated with BPM.

Most processes of real-world businesses are already built (or, “choreographed”) into existing applications. Implementation of explicit BPM solutions for the sake of enabling BAM is generally unfeasible, because implementation of an explicit BPMS solution is disruptive and invariably demands modifications to existing processes. The systems and methods disclosed herein enable automatic configuration of business activity monitoring elements in the absence of a business process management solution, based, e.g., on business process models 120.

A further benefit of the above-discussed aspect of the systems and methods disclosed herein (as described with reference to example system 100), is that it extends the business activity monitoring functionality to integrate with the existing enterprise IT monitoring system framework, to provide a mechanism to link IT events with business events and to facilitate assessment of the business impact of IT events.

The monitoring rules 130 may, for example, be configured to monitor real-world performance of the process, and, in particular to analyze performance of alternative process paths, in cases where a nonlinear process is monitored. Thus, for example, the monitoring rules 130 may monitor the incidence of performance of two or more alternative paths. Excessive performance of more costly alternative paths may thereby be detected automatically, and may be brought to the attention of a business owner, for example by automatically generated and sent reports. In embodiments where the costs of individual activities or steps in the process may be calculated from process information, the monitoring layer 126 may automatically compare the costs of alternative paths, and may identify high rates of performance of more costly paths in comparison to alternative, more cost-effective paths. For example, it may be established with reference to the case data and/or performance data generated by the monitoring system 108 that costly exception paths are performed in the process more often than alternative, more optimal paths.

Process performance may thus be improved by providing visibility and control over end-to-end business process performance. In some embodiments, process owners may automatically be alerted responsive to identification of process performance dips based on the case data and performance data generated by the monitoring system 108.

Although not illustrated in the example embodiments of FIGS. 1 and 2, the system 100 may include a prediction module or prediction engine to predict process performance by reporting process cycle times, volumes, wait times, and exception volumes. Trend analysis may in some embodiments be used to predict process performance.

Yet a further benefit of some embodiments is that business alignment is enabled and promoted by automated determination of association or links between IT system elements and process activities, so that, for example, operational data of IT system elements collected in the example form of IT event alerts may be correlated with corresponding process activities and may in some reports or dashboard displays be overlaid over the process model(s).

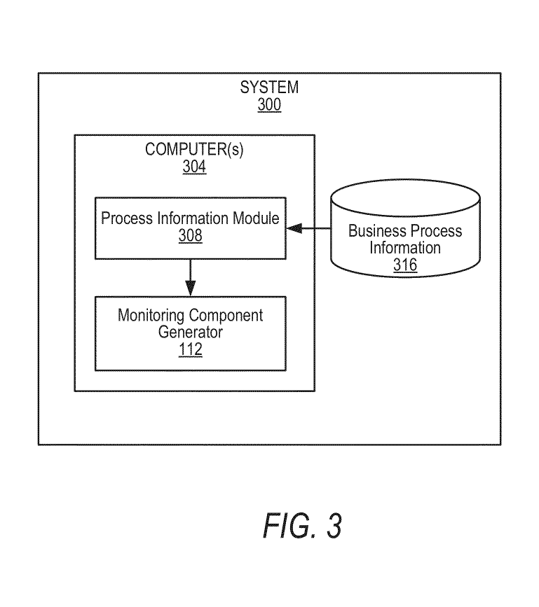

A more detailed example embodiment of a process monitoring system and a monitoring configuration system will now be described with reference to FIGS. 3-14. The example system and methods described with reference to FIGS. 3-14 corresponds broadly in function and configuration to the system 100 of FIGS. 1 and 2, unless explicitly described to operate in a different manner, or unless the context indicates otherwise. Like reference numerals indicate like elements in FIGS. 1-14.

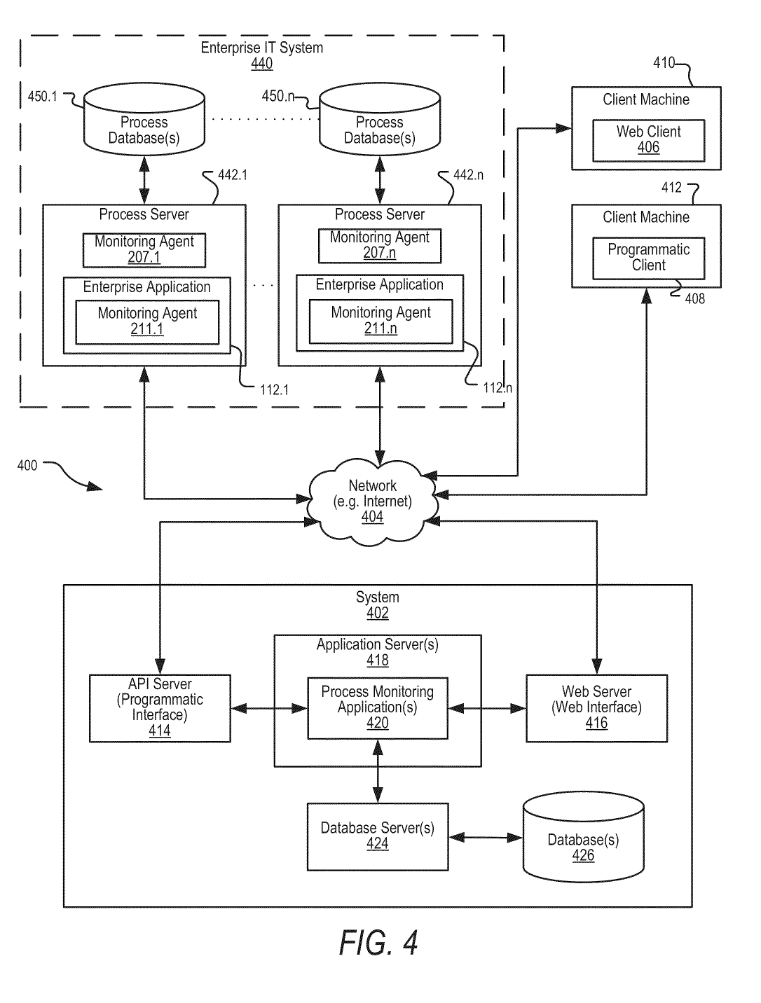

FIG. 3 is a high-level entity relationship diagram of an example configuration of a monitoring configuration system 300. The system 300 may include one or more computers 304 that comprise a process information module 308 to access structured business process information 316 stored in a non-transitory computer readable memory, in this example forming part of a business process database shown diagrammatically in FIG. 3. The business process information 316 may define a plurality of process activities that together comprise a business process that is to be monitored, or a part of a business process that is to be monitored. The system 300 further includes a monitoring component generator 116 to automatically generate one or more monitoring components, based at least in part on the business process information 316, the one or more monitoring components being configured to form part of a monitoring system (another example embodiment of which is described below with reference to FIGS. 4-14) to automatically monitor events with respect to one or more unmanaged enterprise applications that perform at least one of the process activities without central orchestration by a business process management application.

Note that although the system 300 illustrated with reference to FIG. 3 shows, for ease of illustration, a single computer 304 and a single database in which the business process information 316 is stored, the elements of system 300 may, in other embodiments, be provided by any number of cooperating system elements, such as processors, computers, modules, and memories, that may be geographically dispersed or that may form part of a single unit.

### Environment Architecture

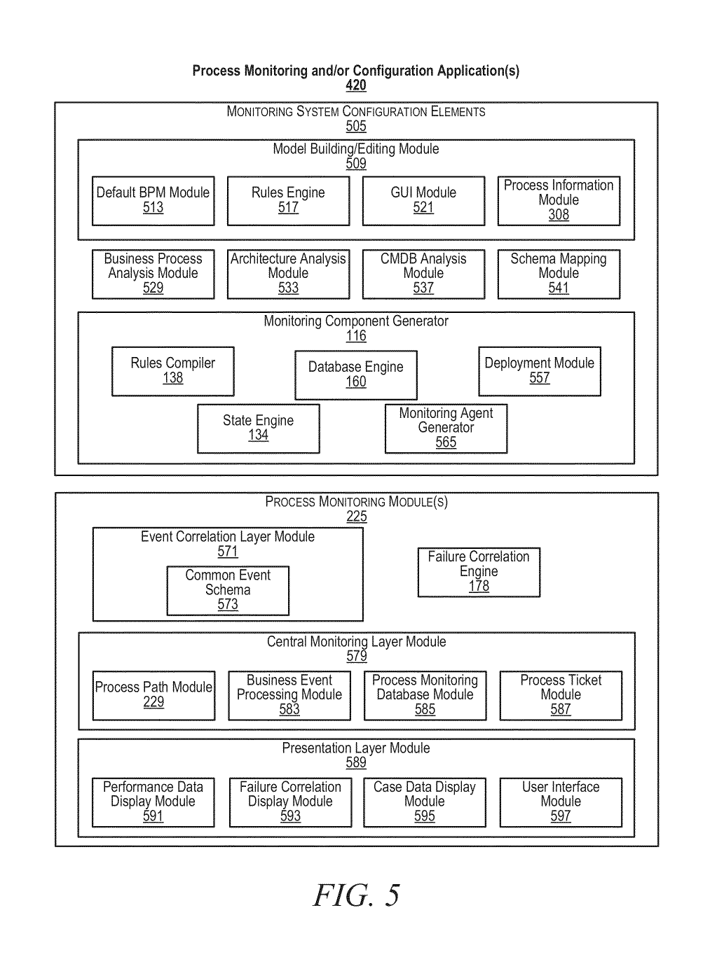

FIG. 4 is a network diagram depicting an example environment architecture 400 within which another example embodiment of a process monitoring system may be employed. It is to be appreciated that the example environment architecture illustrated with reference to FIGS. 4 and 5 (see below) is only one of many possible configurations for employing the methodologies disclosed herein.

A process configuration and monitoring system 402 in this example embodiment provides server-side functionality via a network 404 (e.g., the Internet, a Wide Area Network (WAN), or a Local Area Network (LAN), to one or more clients. FIG. 4 illustrates, for example, a web client 406 (e.g., a browser, such as the Internet Explorer browser developed by Microsoft Corporation of Redmond, Wash. State), and a programmatic client 408 executing on respective client machines 410 and 412.

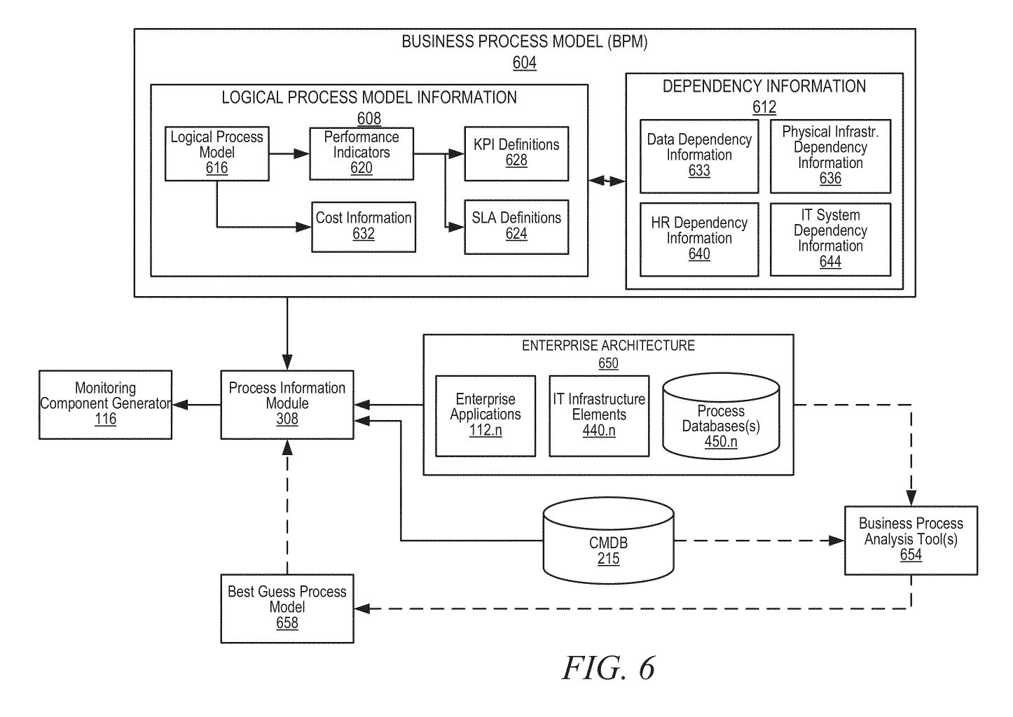

An Application Program Interface (API) server 414 and a web server 416 are coupled to, and provide programmatic and web interfaces respectively to, one or more application server(s) 418. The application server(s) 418 host one or more process monitoring and/or configuration application(s) 420 (see FIG. 5). The application server(s) 418 are, in turn, shown to be coupled to one or more database server(s) 424 that facilitate access to one or more database(s) 426. The database(s) 426 may include, for example, a case data store(s) 158 (FIG. 1) to store case data and performance data of market instances of the relevant business process; a CMDB 215 (FIG. 2) that stores configuration data of enterprise architecture or components; business process information 316 (FIG. 3) that may store, e.g., information with respect to business process model information, operationalization data of the business process, etc. An example embodiment of structured business process information 316 on which the automatic generation of process monitoring components may be based is described in greater specificity with reference to FIG. 6 below.

The system 402 is in communication with an enterprise architecture in the example form of an enterprise IT system 440 that supports and executes at least part of a business process which may be monitored by the process monitoring and/or configuration application(s) 420. The process monitoring and/or configuration application(s) 420 may be in communication with components of the IT system 440, in particular being in communication with a number of process servers 442.n forming part of the IT system infrastructure 203 (FIG. 2) of the IT system 440. Each of the process servers 442.n supports one or more enterprise applications 112.n. Each enterprise application 112.n provides functionalities employed in the performance of an associated process activity or process supported by the IT system 440. Each process server 442.n may be in communication with one or more associated process datastore in the example form of process databases(s) 450.n, to read and/or write associated process data to the respective process databases(s) 450.n. In this example, the enterprise applications 112.n are unmanaged applications, in that the process activities that they perform are not orchestrated by a central business process management application, but are instead executed independently under the direction of the respective applications, although the activities of the respective enterprise applications 112.n may be centrally monitored by the system 402.

For example, enterprise application 112.1 may comprise an accounting application, the process data in the associated process databases(s) 450.1 comprising client account information, while another enterprise application 112.2 (not shown) may comprise a case management application, the process data in an associated process databases(s) 450.2 (not shown) comprising records of respective cases processed by the IT system 440. It will be appreciated that the IT system 440 may comprise any number of process servers 442.n and process databases(s) 450.n, but FIG. 4 shows only two such process servers 442.n, for clarity of description. It is further to be appreciated that communication and interfacing between respective process servers 442.n may occur via the network 404, while some of the process servers 442.n may be in direct communication with one another. It is further to be noted that although communication between the process monitoring and/or configuration application(s) 420 and the IT system 440 in this example embodiment comprises communication with the process servers 442.n, business process monitoring may in other example embodiments be performed with respect to any suitable IT system element by which process activities or operations are performed, or that contains process information pertaining to the process activities that are monitored. Note further that there is not necessarily a one-to-one relationship between enterprise applications 112.n, process servers 442.n, process databases(s) 450.n, and any other elements indicated by the reference numeral suffix .n, which is used for clarity of description to indicate that any number of instances of the respective components may be present.

As mentioned above with reference to FIG. 2, at least some of the IT system elements, such as the process servers 442.n, may have associated infrastructure monitoring agents 207.n to generate IT event alerts with respect to IT events occurring on the associated IT infrastructure element, and to communicate the event alerts to the monitoring system 402. One or more of the enterprise applications 112.n may likewise be configured to include respective application monitoring agents 211.n to record and/or report to the monitoring system 402 the occurrence of events at the associated enterprise application 112.n, for example including IT events and application events. Such event alerts from the infrastructure monitoring agents 207.n and/or the application monitoring agents 211.n may be communicated to the system 402 automatically and continuously. For example, an infrastructure monitoring agent 207.n may automatically report occurrence of an IT event such as failure of the associated process server 442.n, configuration changes in the process server 442.n, malperformance of a particular component of the process server 442.n, and the like. An application monitoring agent 211.n may likewise report IT events occurring at the associated enterprise application 112.n, such as when the application crashes, is restarted, is reconfigured, or the like, and may instead, or in addition, report application events occurring at the associated enterprise application 112.n, such as case data with respect to operations performed by the enterprise application 112.n in particular instances of the process activities performed by the enterprise application 112.n.

The process monitoring and/or configuration application(s) 420 may provide a number of functions and services, including, for example, the provision of process monitoring and process configuration functionality. Respective modules for providing these functionalities are discussed in further detail with reference to FIG. 5 below. While all of the functional modules, and therefore all of the process monitoring and/or configuration application(s) 420 are shown in FIG. 5 to form part of the system 402, it will be appreciated that, in some embodiments, some of the functional modules or monitoring/configuration applications may form part of systems that are separate and distinct from the system 402. Further, while the architecture 400 shown in FIG. 4 is a client-server architecture, the example embodiments are not limited to such an architecture, and could equally well find application in, for example, a distributed or peer-to-peer architecture system. The process monitoring and/or configuration application(s) 420 could also be implemented as standalone software programs, which do not necessarily have networking capabilities. The latter configuration may, for example, be provided in a business environment in which the enterprise IT system 440 is located at a geographically confined business premise in which the IT system elements communicate via a LAN.

In an example embodiment that employs the architecture 400 illustrated in FIG. 4, the web client 406 may access the process monitoring and/or configuration application(s) 420 via the web interface supported by the web server 416. Similarly, the programmatic client 408 may access the various services and functions provided by the process monitoring and/or configuration application(s) 420 via the programmatic interface provided by the API server 414.

### BPM Application(s)

FIG. 5 is a schematic block diagram illustrating multiple functional modules of the process monitoring and/or configuration application(s) 420 of system 402. Although the example modules are illustrated as forming part of a single application, it will be appreciated that the modules may be provided by a plurality of applications The modules of the application(s) 420 may be hosted on dedicated or shared server machines (not shown) that are communicatively coupled to enable communication between server machines. At least some of the modules themselves are communicatively coupled (e.g., via appropriate interfaces) to each other and to various data sources, so as to allow information to be passed between the modules or so as to allow the modules to share and access common data. The modules of the application(s) 420 may furthermore access the one or more database(s) 426 via the database server(s) 424 (FIG. 4).

The system 402 may provide a number of modules whereby a user may build or define structured business process information, for example in the form of a business process model(s). The modules may operate to automatically configure at least some monitoring components of the system 402, selectively configure some aspects of the process monitoring system 402, automatically monitor execution of activities forming part of the business process, to identify correlations between process failures and IT system failures, and/or display the results of the process monitoring. In this example embodiment, the process monitoring and/or configuration application(s) 420 include monitoring system configuration elements 505 that provide a process monitoring configuration system 104 aspect of the system 402 (see for example FIG. 1) to allow configuration of a process monitoring system 108 aspect of the system 402. The aspect of the system 402 that comprises the process monitoring system 108 may be provided by process monitoring module(s) 225 forming part of the process monitoring and/or configuration application(s) 420.

The monitoring system configuration elements 505 may include a model building/editing module 509 to enable a user or administrator to define an enterprise-specific business process model, either by editing, adapting, or building on a selected default enterprise model, or by building a business process model from scratch. To this end, the model building/editing module 509 is shown to include at least one default BPM module 513 to provide default business process models (BPMs) which are to serve as bases for a user to define a business process model specific to a particular process.

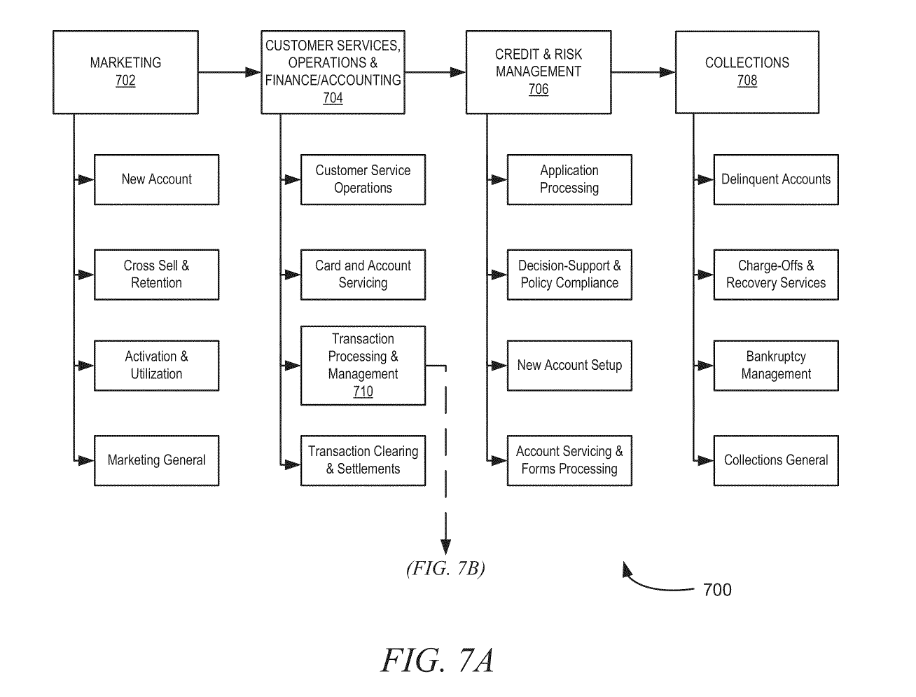

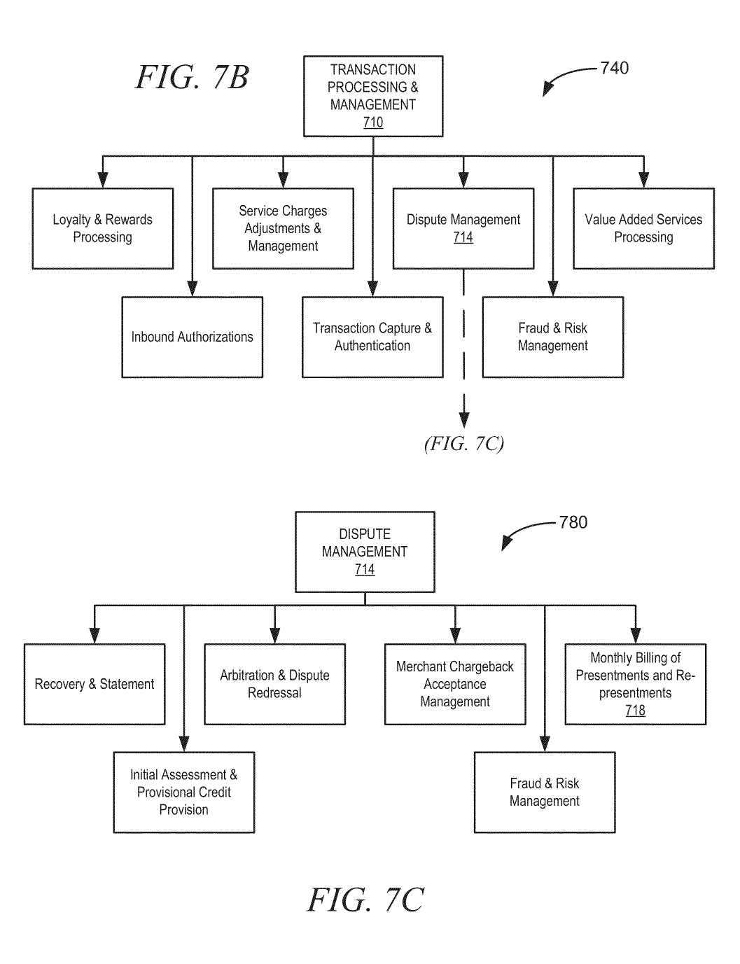

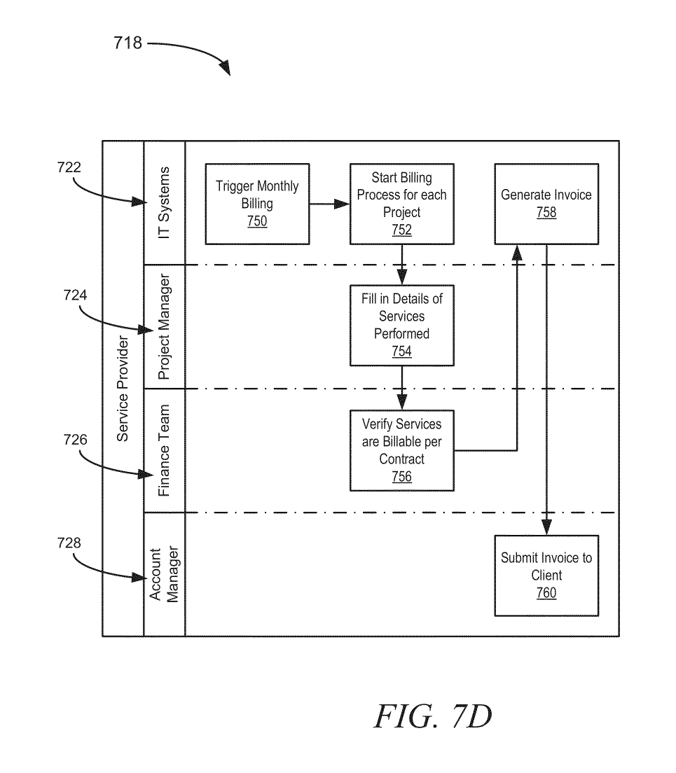

The default BPMs may be predefined by a supplier of the process monitoring and/or configuration application(s) 420 and are in respect to generic business processes relating to a variety of types of businesses or types of business activities. A user may thus, as a starting point for defining an enterprise-specific BPM, select one or more default process models which most closely approximate the business processes performed by the IT system 440. The default BPM module 513 may provide default logical process models indicating a series of activities, without specific operationalization information indicating particular process elements or support elements on which the activities are dependent. The model building/editing module 509 also enables the editing of the BPM in response to changes in the business process, for example if the user wishes to redesign or reengineer the BPM. An example BPM is described in greater detail with reference to FIGS. 6-7 below.

A graphic user interface (GUI) module 521 is provided to generate and manage an interactive GUI to display various aspects of the process model, and to permit user management of the BPM. In instances where the process which is to be monitored comprises a large number of activities (e.g., instances where the BPM is an enterprise model), it may be impractical to display a representation of all of the processes and/or an entire business architecture in a single view, and the GUI will allow user selection of different levels or layers of the enterprise model for viewing. Such drill-down functionality is described in greater detail below with reference to FIG. 7.

A process information module 308 provides functionality to permit the input of data for use in process modeling or process description in order to provide structured business process information upon which the automatic generation of monitoring components can be based. The process information module 308 may be configured for manual input of this information, and may instead or in addition provide for automatic acquisition of relevant data from other databases. In instances in which a business process which is to be monitored has not yet been modeled, or in which the user 124 does not wish to generate a comprehensive business process model, the structured business process information upon which process monitoring is to be based may be provided by the user 124 via the process information module 308 in the form of a best-guess business process model of existing business process activities generated with the assistance of the business process analysis tools. The system 402 may thus include a business process analysis module 529 by means of which the user 124 may analyze existing business processes in manual, automatic, or semiautomatic fashion, depending on the particular configuration of the business process analysis module 529 and the enterprise IT system 440.

In this embodiment, the system 402 further includes a number of modules that are configured to integrate with the enterprise architecture and/or a configuration management system of the enterprise IT system 440 to determine or calculate links and associations between process activities, the enterprise applications 112.n and the system infrastructure of the enterprise IT system 440. To this end, the system 402 may include an architecture analysis module 533 to integrate with the enterprise IT system 440 (for example interrogating and/or communicating with IT system elements such as the process servers 442.n and/or the process databases(s) 450.n). The system 400 may further include a CMDB analysis module 537 to integrate with the CMDB 215 (see FIG. 2) to figure out asset details of IT system elements, in some instances including the asset details of the enterprise applications 112.n.

The model building/editing module 509 may further include a rules engine 517 to permit user-definition of performance metrics by which performance of business processes is to be measured. A user may thus provide, via the rules engine 517, performance measures that may include a definition of performance indicators such as key performance indicators (KPIs). Such performance indicators may serve to provide quantifiable performance measurement of an associated process or process activity. KPIs may, for example, measure the cost or completion time of particular processes and/or activities. In an example embodiment, the structured business process information may include information regarding service-level agreements (SLAs) which specify, in measurable terms, contractual service commitments, which are defined as minimum performance criteria for business processes as a whole and/or for respective process activities or groups of process activities. Failure to comply with the requirements of a particular SLA may be specified as constituting a failure of the associated process.

The monitoring system configuration elements 505 may further include a schema mapping module 541 to facilitate the creation of schema mappings to map respective schemas of the enterprise applications 112.n to a common event schema 573 that is to be used by the application events correlation layer 142 (see FIG. 1) in the mapping of the application events generated by the respective enterprise applications 112.n. In some embodiments, the schema mappings are entered manually by a business user 124 or administrator via the schema mapping module 541. In some embodiments, the schema mapping module 541 is operable to parse an event model(s) provided by the user 124, and to automatically generate at least some of the schema mappings.

The monitoring system configuration elements 505 may further include the monitoring component generator 116 that is configured to automatically generate one or more monitoring components of the monitoring system 108 aspect of the system 402. In this example, the monitoring component generator 116 includes the rules compiler 138 to generate monitoring rules that are to be used in the central monitoring layer 126 (FIG. 1) to monitor the target business process and/or process activities based on business event information supplied to the monitoring layer 126 by the application events correlation layer 142 (FIG. 1). The monitoring component generator 116 further includes the state engine 134 that is configured to generate structured process state information in the example form of process state definitions to be employed by the central monitoring layer 126 to correlate business event information to the particular process activities defined by the structured business process information upon which automatic generation of the state definitions by the state engine 134 is based. The monitoring component generator 116 may also include a database engine 160 that is configured to automatically generate database elements upon which configuration of the case data store(s) 158 is to be based. In some embodiments, the database engine 160 is arranged to automatically configure the case data store(s) 158 responsive to the generation of the database elements (such as database facts and dimensions discussed with reference to FIG. 1).

In this example embodiment, the monitoring component generator 116 also includes a monitoring agent generator 565 to generate the application monitoring agents 211.n and/or the infrastructure monitoring agents 207.n. A deployment module 557 may be provided to effect deployment of the above-described monitoring components to the respective elements of the monitoring system 108 aspect of the system 402.

The process monitoring module(s) 225 that, at least in part, provides the monitoring system 108 aspect of the system 402, may include an event correlation layer module 571 to implement the event correlation layer 142. To this end, the event correlation layer module 571 may include the common event schema 573. The event correlation layer module 571 is therefore operable to receive application event information in the form of application event alerts from the application layer 146, to map the application events to business events, and to communicate business event information indicating the identified business events to the central monitoring layer 126.

The process monitoring module(s) 225 may further include a central monitoring layer module 579 to implement or provide the central monitoring layer 126 (see FIG. 1). In this embodiment, the central monitoring layer module 579 includes a business event processing module 583 to receive the business event information from the application events correlation layer 142, and to correlate the business events indicated by the business event information to particular process activities identified in the structured business process information and upon which generation of the process state definitions 128 by the state engine 134 may, at least in part, be based (FIG. 1).

The central monitoring layer module 579 may further include the process path module 229 to identify, for each monitored instance of the business process, which of a plurality of alternative paths to be followed, based on the relevant case data. It will be appreciated that operation of the process path module 229 is applicable to business processes that include one or more decision points where alternative paths or branches of the business process diverge. The process path module 229 may thus identify not only which of the plurality of paths a particular instance should follow, but may also correlate the actual monitored process activities for each instance to the correct process path, thereby identifying when an incorrect decision path is followed in any particular instance of the process. The central monitoring layer module 579 may further include a process monitoring database module 585 to communicate case data and/or performance data generated based on the business event information that it receives to the case data store(s) 158.

The central monitoring layer module 579 is configured to identify process failures, e.g., based on the monitoring rules 130 created by the rules compiler 138, and may further be configured to automatically generate a process incident ticket and communicate it to the MoM 170 (see FIGS. 1 and 2). To this end, the central monitoring layer module 579 may include a process ticket module 587. Process failures may be identified, for example, responsive to nonperformance of a particular process activity that should have been performed according to the process state definitions 128 generated based on the structured business process information. Thus, for example, if a defined change of one process state to another for a particular process instance is overdue, nonperformance of the associated process activity may be inferred. The monitoring rules 130 may specify particular criteria for identifying process failure, for example stipulating that nonperformance of process activities within predetermined time periods constitutes process failure, a particular SLA violation (or all SLA violations) constitute process failure, that deviation from the correct process path (as identified by the process path module 229) constitutes process failure, and any other appropriate criteria.

The process monitoring module(s) 225, in this example, may also include the failure correlation engine 178 to correlate identified process failures to IT system failures such as infrastructure failures, application failures, and/or data failures.

A presentation layer module 589 may be provided to implement the presentation layer 162 (see for example FIG. 1). The presentation layer module 589 may include a performance data display module 591 to generate the dashboard 166 (FIG. 1) on one or more display devices and/or end-user devices, the dashboard including real-time or near real-time display of case data and/or performance data with respect to the monitored instances of the business process. The process monitoring provided by the system 402 in this example embodiment is real-time or near real-time, in that monitoring of performance of process activities by the enterprise applications 112.n is performed by automatic reception by the process monitoring layer 126 of business event information, as opposed to the gathering of information by polling or interrogating data repositories such as the process databases(s) 450.n. Event information is, for example, pushed by the application layer 146 to the application events correlation layer 142, by the application events correlation layer 142 to the central monitoring layer 126, and by the central monitoring layer 126 to the case data persistence layer 154, in contrast to pulling of information from the enterprise infrastructure elements, such as the process databases(s) 450.n.

The performance data display module 591 may be configured to automatically display performance indicators and/or case data based on the database facts and/or dimensions of the case data store(s) 158. The presentation layer module 589 may further include a failure correlation display module 593 to display information regarding process failures indicated by respective process tickets, and to display any identified correlation between process failures and IT failures. The presentation layer module 589 may yet further include a case data display module 595 to display case data of particular cases of the business process. As used herein, a particular instance of the business process is referred to as a case. The presentation layer module 589 may also include a user interface module 597 to allow a user to alter the display of the dashboard 166, to request particular performance data or case data, and to select particular reports and/or graphs based on the case and performance data.

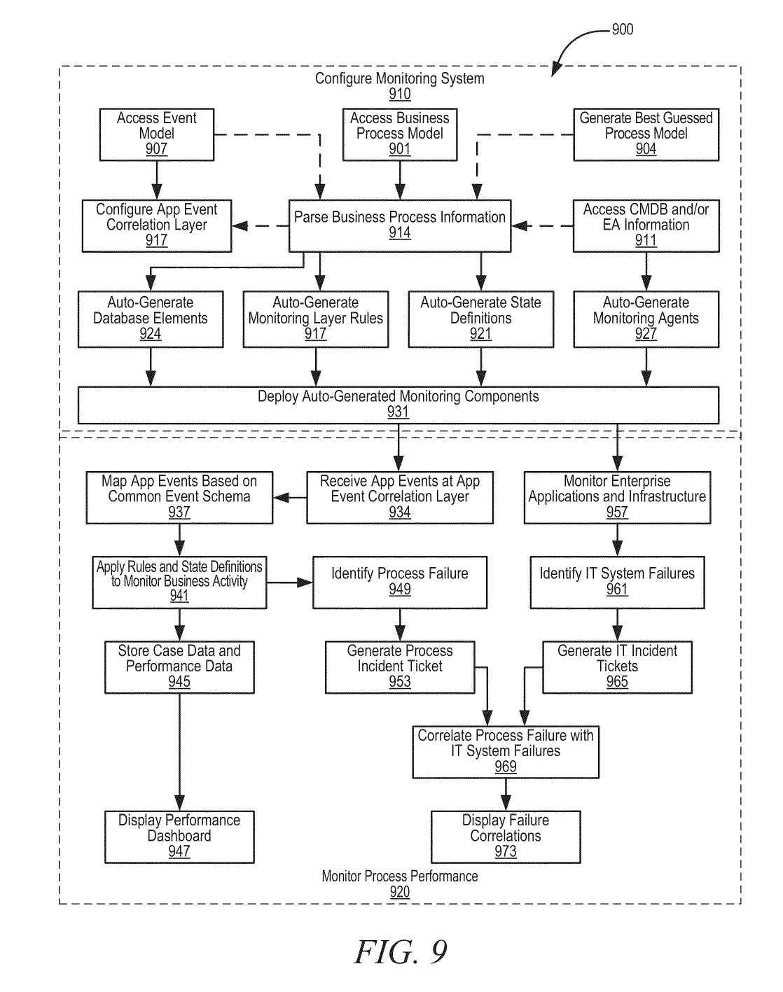

Further functionalities of the process monitoring and/or configuration application(s) 420 are described with reference to an example method described below with reference to FIG. 9.

### Data Structures

FIG. 6 is an entity-relationship diagram, illustrating various tables, data repositories, and databases that may be maintained within the databases 426 (FIG. 4), and that may be utilized, maintained, and/or generated by the process monitoring and/or configuration application(s) 420. As shown in the figure, the configuration of the process monitoring system 108 is based at least in part on a BPM. Instead, or in addition, the automatic generation of process monitoring components may be based at least in part on a best-guess process model 658 generated, in this example, by analysis of the CMDB 215 and enterprise architecture 650 with the assistance of business process analysis tool(s) 654. Entity relationships pertaining to generation of the best-guess process model 658 are shown in FIG. 6 in broken lines. Note that, in some embodiments, structured business process information that is provided to or received by the process information module 308 for use by the monitoring component generator 116 to generate the monitoring components may be hybrid information comprising both BPM 604 information and custom-generated process analysis results, such as a best-guess process model 658.

Thus, the databases 426 may include business process model information in the form of a structured BPM 604, in the current example being in process-standard notation. The BPM 604 may include logical process model information 608 together with operationalization data in the form of dependency information 612.

The logical process model information 608 may include a logical process model 616 comprising structured data defining the activities constituting the business process, and showing relationships between respective process activities. The process activities may include, for example, process steps, process operations, or the like. In the current example, the logical process model 616 may be a logical process model defining the sequence of process activities abstractly, without defining relationship of the activities or processes to process elements associated with operationalization of the process, which may be provided by the dependency information 612.

The logical process model 616 may reference defined performance measures in the example form of performance indicators 620 that may include service-level agreement (SLA) definitions 624 and key performance indicator (KPI) definitions 628. The performance indicators 620, SLA definitions 624, and KPI definitions 628 may be user-specified via the rules engine 517 (FIG. 5). The logical process model 616 may further reference cost information 632 that indicates a cost of respective activities or sub-processes. Such cost may be expressed, for example, in employee-hours, currency, resource load, or the like.

The dependency information 612 may comprise structured information regarding dependencies of respective processes and/or process activities on process elements. The dependency information 612 may include IT system dependency information 644 that comprises information regarding process dependence on IT system elements of the IT system 440. The IT system dependency information 644 may thus include information regarding dependency of processes or activities on software such as enterprise applications 112.n, as well as dependency on IT infrastructure. In this regard, IT infrastructure refers to the hardware, as configured and arranged, within the IT system 440. IT infrastructure information may thus include the properties, status, configuration, and relationships of hardware components such as particular servers, machines, and/or interfaces in the IT system 440. The term “IT system” includes the IT infrastructure and software (e.g., enterprise applications 112.n) supported by the IT infrastructure.

The dependency information 612 may further include human resources (HR) dependency information 640 in which is stored structured information regarding the dependency of respective processes or process activities on particular HR components, such as people or personnel. The HR dependency information 640 may for example specify the job role or personnel department responsible for the performance of a particular process activity.

Physical infrastructure dependency information 636 may also be included in the dependency information 612 to indicate the dependency of respective process activities on physical infrastructure components. Such physical infrastructure components may include, for example, vehicles, machinery, supply-chain elements, buildings, and the like. The dependency information 612 may also include data dependency information 633 that may indicate dependency of process activities on data quality and/or data availability. The data dependency information 633 may also indicate dependency of respective process activities and/or enterprise applications 112.n on process databases(s) 450.n that are not directly read from or written to by the particular enterprise application 112.n in executing the respective process activity, but which form a link in a data chain to supply data to process databases(s) 450.n upon which the enterprise application 112.n directly depends.

In the absence of an explicit definition of dependency information in a BPM 604, the system 402 may thus facilitate determination of system element dependency information by interrogating the enterprise architecture 650 and/or the CMDB 215. Identification of links between process activities, enterprise applications 112.n, and IT infrastructure elements enables the system 402 to assess the impact of IT failures on process activities and processes, and provides accurate identification not only of correlation between process failures and system failures, but also of causation of particular process failures by one or more underlying system failures. In other embodiments, the CMDB 215 and/or enterprise architecture 650 may instead, or in addition, be communicatively coupled to the failure correlation engine 178 (FIG. 1), so that the failure correlation engine 178 is configured to access the CMDB 215 and/or the enterprise architecture 650 during process and system failure correlation and/or causation identification.

### Example Logical Process Module

The concept of a logical process model 616 described above will now be further explained with reference to extracts from example GUIs that may be generated by the GUI module 521 (of FIG. 5) according to an example embodiment. In FIG. 7A, reference numeral 700 generally indicates an example graphical representation of a value chain diagram providing an overview of an example business process defined by the business process model 604 (of FIG. 6). The value chain represents the chain of business activities that generate value for an enterprise.

The example value chain diagram 700 can be used to represent a business which provides credit card services to customers. The value chain diagram 700 represents a highest level of the enterprise model and comprises, at the highest level, a series of organizational units. In this example, the value chain diagram 700 comprises the organizational units of Marketing 702; Customer Services, Operations and Finance/Accounting 704; Credit and Risk Management 706; and Collections 708.

Note that, at the highest level of the value chain, different enterprises in a particular industry or field of business may be somewhat similar. For example, many computer chip manufacturing firms have a similar sequence of elements, such as fabrication. However, the enterprise model includes further levels which indicate the organization of a particular enterprise, and in the lower levels there may be great differences between respective enterprises in the same field.

The particular organization of an enterprise may be influenced by the scale of operations, the history of the enterprise, and a variety of other factors. For instance, two cable TV companies operating in adjacent markets and offering nearly identical products may be completely different in their organization at lower levels. In other examples, the value chain diagram may decompose the enterprise process, at a high level, according to business domains. In this regard, “business domain” is understood to comprise a particular line of business. For example, in a financial services organization, domains can include Deposits, Loans, Investments, and Insurance. Such domains can be further decomposed into sub-domains. A business domain of Loans can for instance include Corporate Loans and Personal Loans sub-domains.

As illustrated in FIG. 7A, the value chain diagram 700 specifies the functional decomposition of each of the organizational units 702 to 708 into respective series of functions or processes. Thus, for example, the organizational unit of customer services, operations and finance/accounting 704 comprises a series of functions or processes. A user can view further organizational details or functional decomposition of each of the functional processes constituting the organizational unit by selecting the associated function or process in the GUI. Organizational units may thus be categorized by the function they perform. It is to be noted that functions may be specific to a business domain/sub-domain, or may be shared across domains/sub-domains. For example, recruiting and other human resource functions may be shared functions, while warehouse operations may be specific to a sales and distribution area of a large retailer.

In FIG. 7B, reference numeral 740 generally indicates functional decomposition of the function of Transaction Processing and Management 710, specifying a series of sub-functions which includes Dispute Management 714. The diagram 740 of FIG. 7B is thus a lower-level view of one of the functions forming part of the diagram 700 of FIG. 7A, and it will be appreciated that each of the functions shown in FIG. 7A may similarly be viewed at a lower level.

Likewise, diagram 780 in FIG. 7C shows further functional decomposition of the sub-function of Dispute Management 714, which comprises a series of processes forming part of the Dispute Management 714 sub-function. One of these processes is Monthly Billing of Presentments and Re-Presentments 718. A user can select any one of the processes of FIG. 7C, to view a part of the logical process model 616 (FIG. 6) specifying a series of activities comprising the process, as well as dependency information 612 (FIG. 6) of the process activities. A GUI representative of part of such an example process model for the process of Monthly Billing of Presentments and Re-Presentments is generally indicated by reference numeral 718 in FIG. 7D. It is to be appreciated that the user may thus drill down to a specific part of the BPM 604, as exemplified by the various levels of the BPM 604 illustrated in FIGS. 7A-7D. The number of levels of the enterprise model may vary depending on the complexity of the enterprise, and may well exceed the limited number shown here.

The process model shown in the example GUI of FIG. 7D may include a part of the logical process model 616 indicating a sequence of activities 750-760. Human resource dependency information 640 is indicated in the GUI by location of blocks representing the activities 750-760 in one of a number of bands 722-728. In the example GUI of FIG. 7D, only HR dependency information 640 is shown, but it will be appreciated that other dependency information, such as IT system dependency information 644, physical infrastructure dependency information 636, and data dependency information 633 (FIG. 6) may also be depicted in other embodiments.

The example process of FIG. 7D is initiated by an activity to trigger monthly billing at block 750. This activity is performed automatically by the IT systems, as indicated by its being located in the IT systems band 722. The process further includes the step activity of starting a billing process for each project, at block 752. The next activity in sequence is to fill in details of services performed, at block 754. This activity is to be performed by a project manager, as indicated by location of the block 754 in the project manager band 724. Thereafter, the process comprises the activity of verifying that services are billable according to contract, at block 756. This activity depends on the human resource component of the finance team, indicated by finance team band 726. After verification that services are billable, at block 756, the process model includes an activity for generating an invoice, at block 758. Finally, invoices are submitted to the client, at block 758, by an account manager indicated by the associated band 728. Operations within the bands 722-728 may be entirely automated.

### Flowcharts

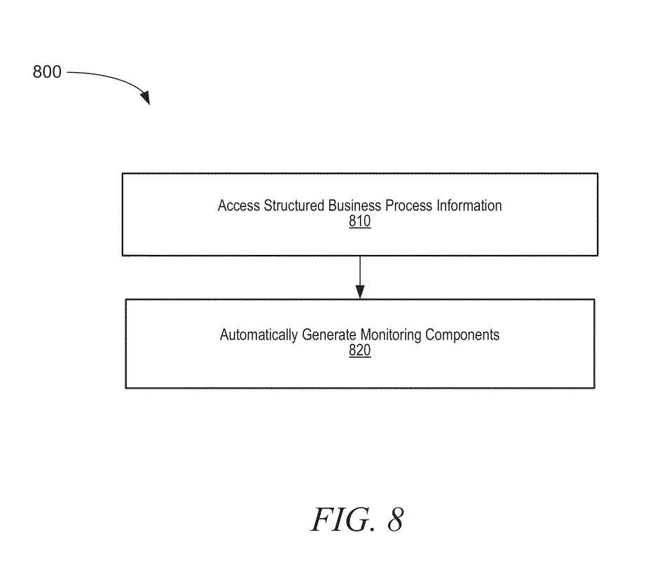

An example method will now be described with reference to FIGS. 8-10. In this embodiment, the method described below is performed by the example system 402 described with reference to FIGS. 4-6 above. The method described below implements a process monitoring system and a process monitoring configuration system that has at least some elements similar to or identical to those discussed with reference to FIG. 1, and like reference numerals are used to indicate like elements in FIGS. 1-10. Note that the various modules, engines, systems, memories, databases and other elements provided by the example system 402 need not necessarily be arranged as illustrated with reference to FIGS. 4-6, but may have any convenient configuration to provide the relevant functionalities.

FIG. 8 shows a high-level flowchart of a method 800 to configure a process monitoring system. The method 800 comprises accessing structured business process information that defines a business process comprising a plurality of process activities, at operation 810, and automatically generating, at operation 820, one or more monitoring components of a monitoring system that is arranged to monitor events with respect to one or more unmanaged enterprise applications. The unmanaged enterprise applications perform at least one of the process activities without orchestration by a business process management application. Automatic generation of the monitoring components is based, at least in part, on the structured business process information.

FIG. 9 shows a more detailed flowchart of a method 900 to configure a process monitoring system and to monitor a business process. The method 900 may therefore comprise a method 910 to configure a process monitoring system 108 (see for example FIG. 1), and a method 920 to monitor process performance of a business process by use of at least the configured monitoring system 108.

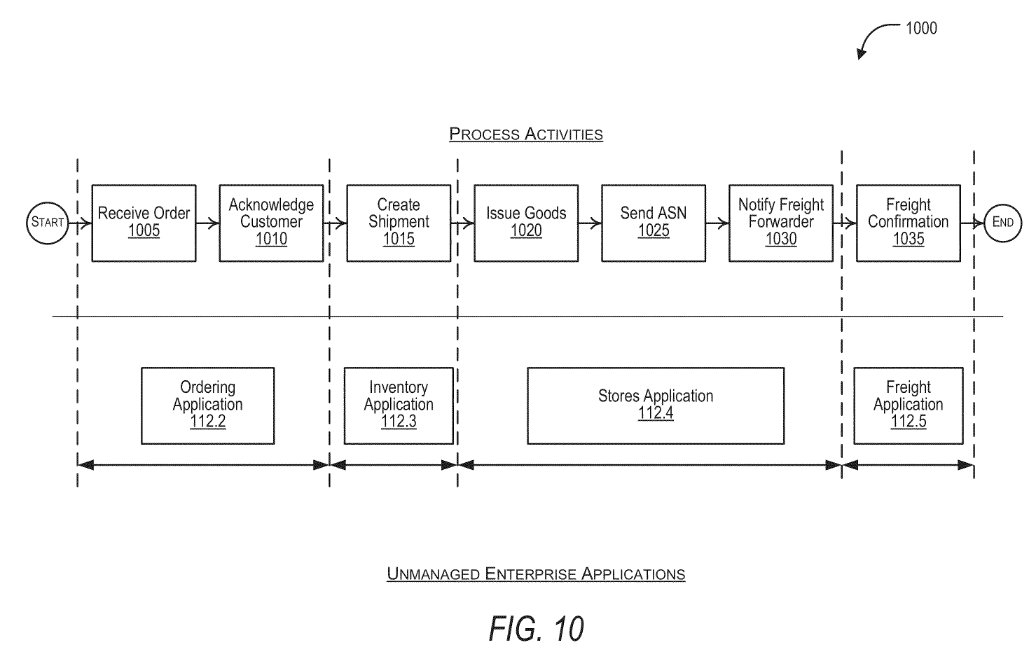

The method 900 will be described with reference to an example business process 1000 illustrated schematically in FIG. 10. The example process 1000 is an order to cash process flow in which four different unmanaged enterprise applications 112.n participate. Each of the enterprise applications 112.n receives instructions and performs some internal processing with respect to individual orders, whereafter the order is sent to a subsequent enterprise application 112.n.

As can be seen with reference to FIG. 10, an ordering application 112.2 receives, at operation 1005, an order from a customer (not shown), for example via the Internet, and upon successfully saving the new order, the ordering application 112.2 sends an acknowledgment, at operation 1010, to the customer with a unique order identification number (order ID). The ordering application 112.2 then posts the order to an inventory application 112.3 that checks the available inventory and creates a Shipment for the order, at operation 1015.

The inventory application 112.3 then transmits the Shipment to a stores application 112.4 that issues the ordered goods, at operation 1020, based on Shipment line items. When all the goods for line items of the Shipment have been issued, the stores application 112.4 sends out a notification to the customer, at operation 1025. The notification in this example is referred to as an “Advanced Shipment Notification” or ASN. The stores application 112.4 also transmits a notification, at operation 1030, to a freight forwarders application or freight application 112.5 in a business-to-business (B2B) transaction. The freight forwarding business delivers the freight and sends out a confirmation of freight delivery, at operation 1035, via the freight application 112.5.

The business process 1000 thus comprises a series of process activities that are executed by respective enterprise applications 112.n that are unmanaged in that there is no business management application, or indeed any other application, that acts centrally to orchestrate or coordinate the process 1000.

Turning now to FIG. 9, the method 900 may comprise accessing a business process model 901 of the process 1000, if the process 1000 has been modeled previously. Alternatively, the process 1000 may be modeled in real-time, as needed, by a process modeling tool, for example a process modeling tool that supports standard business process notation such as XPDL, BPMN process notation. Such business process modeling may include sufficient information for monitoring.

Instead, or in addition (particularly for more complex business processes), the process 1000 may be analyzed, for example by use of business process analysis tools, to generate a best-guess process model, at operation 904. The structured business process information, whether in the form of a previously existing BPM 604 or a specifically generated process model may thereafter be parsed, at operation 914, for example by the monitoring component generator 116, to automatically generate one or more monitoring components for the monitoring system 108.

The structured business process information that is parsed, at operation 914, may also include an event model that may be accessed at operation 907. The event model may include information defining relationships between process-related events and process activities and/or enterprise applications 112.n. The event model may include data regarding when an event occurred, which process activity it belongs to, the particular application or source that generated the event, and business payload information (that may include, for example, business identifiers, business date times, and business quantities). The method 900 may also include configuring, at operation 917, an application events correlation layer 142 (see FIG. 1), for example by defining the schema mappings for the respective enterprise applications 112.n, to map application events generated by the respective enterprise applications 112.n to the common event schema 573 (see FIG. 5). In some embodiments, the application events correlation layer 142 may at least in part be configured automatically, at operation 917, by the monitoring component generator 116, based on event model information.

The structured business process information that is parsed to automatically configure the monitoring system 108 may include information extracted or determined, at operation 911, from access to integration with the CMDB 215 and/or the enterprise architecture (EA) 650. The relationships between IT infrastructure elements, enterprise applications 112.n, and process activities may be used in the order-generation of application monitoring agents 211.n and/or infrastructure monitoring agents 207.n, at operation 927. Infrastructure relationship information may, however, in some instances also be parsed as part of the business process information, at operation 914, so that automatic configuration of the monitoring system 108 may include definitions of and relationships between the enterprise architecture 650, the enterprise applications 112.n, and the business process activities, for example to facilitate identification of correlations between process failures and IT system failures.

Automatic generation of the monitoring components, and deployment of the auto-generated monitoring components, at operation 931, serves to convert the structured business process information that is provided to the monitoring component generator 116 in a standard notation into a vendor-specific implementation of the monitoring layer 126 (see for example FIG. 1). To this end, the monitoring component generator 116 automatically generates, at operation 921, the state definitions 128 that define the business process 1000 in the monitoring layer 126 and with reference to which performance of the process 1000 is to be monitored.

Further, monitoring layer rules in the example form of the monitoring rules 130 may be auto-generated at operation 917. The monitoring rules 130 may, as described previously, comprise rules defining a process failure or process incidents, define actions to be taken by the monitoring layer 126 responsive to occurrence of particular events, define criteria for deciding between alternative process paths at decision points, and the like. The monitoring rules 130 may therefore configure the monitoring layer 126 to generate process alerts based on violation of SLAs defined in the monitoring rules 130.

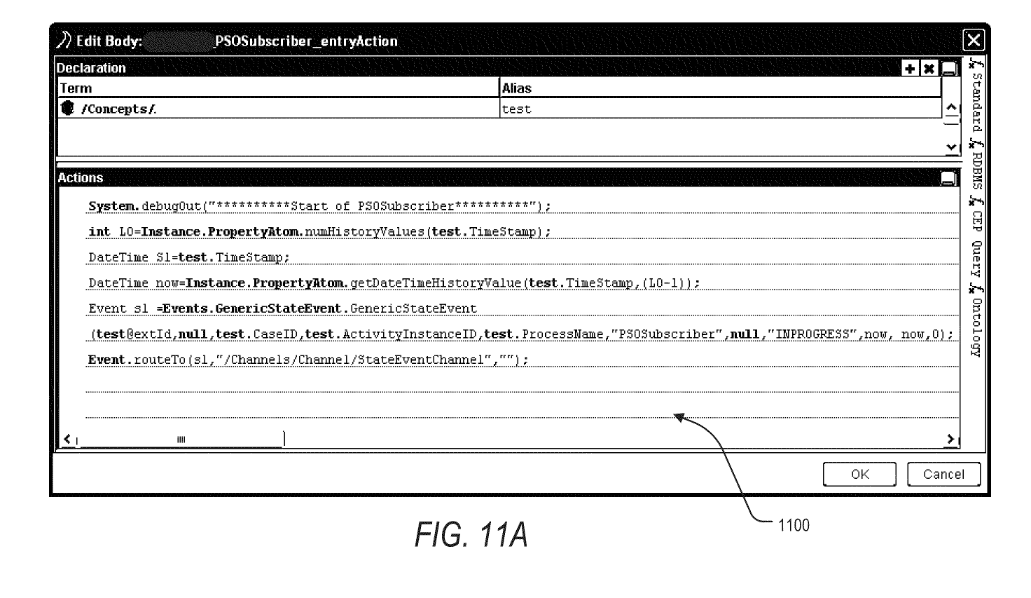

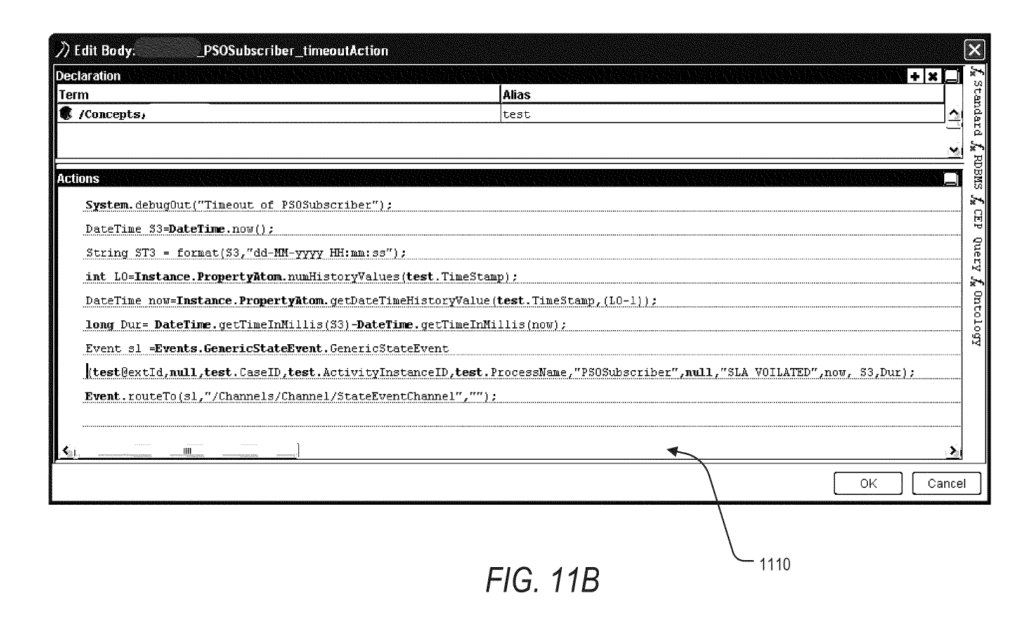

FIG. 11A shows an example of a monitoring rule 1100 to form part of the monitoring rules 130 in the monitoring layer 126, the rule 1100 being auto generated in this example embodiment to take action against an incoming event. The functionality of the example rule 1100, as illustrated in FIG. 11A, will be evident to a person of ordinary skill in the art and is not described in further detail herein. FIG. 11B shows another example rule 1110 to configure the monitoring layer 126 to take specific actions when an SLA is violated. As is the case with rule 1100, the functionality of rule 1110 is evident to those of ordinary skill in the art, and will therefore not be described in further detail herein.

Referring again to FIG. 9, the method 900 may further comprise automatically generating database elements, at operation 924, to automatically configure the case data store(s) 158 (see FIG. 1) based on the structured business process information. The database elements thus generated may include a database schema comprising database facts, dimensions, and metadata definitions.

Monitoring agents in the example form of application monitoring agents 211.n and infrastructure monitoring agents 207.n (see FIG. 2) may also be generated automatically, at operation 927, the functionality of which is described above with reference to FIG. 2.

The automatically generated monitoring components may thereafter be deployed, at operation 931, to the process monitoring system 108, so that the monitoring system 108 is custom-configured for the particular business process that is monitored. The configuration system 104 therefore automatically configures at least some parts of the monitoring layer 126 and/or the case data persistence layer 154. In some embodiments, at least some automatic configuration of the application events correlation layer 142 may be performed based on event model data. In instances where application monitoring agents 211.n are deployed to the application layer 146, the configuration system 104 may automatically configure at least part of the application events correlation layer 142 as well.

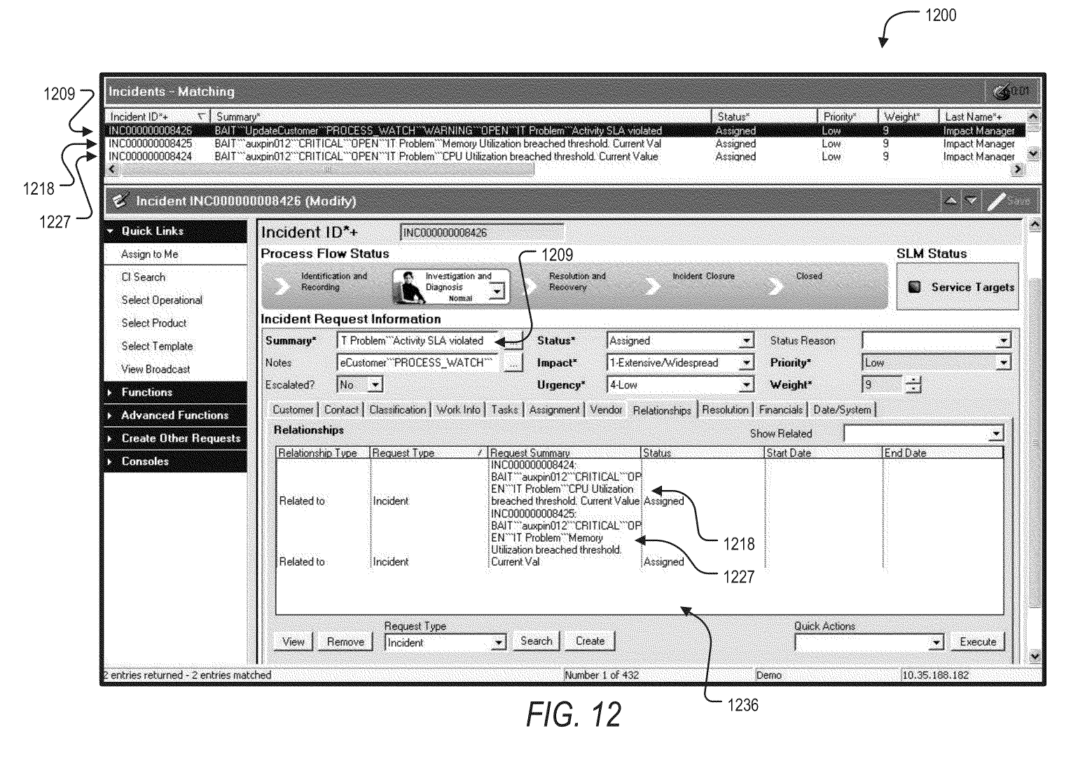

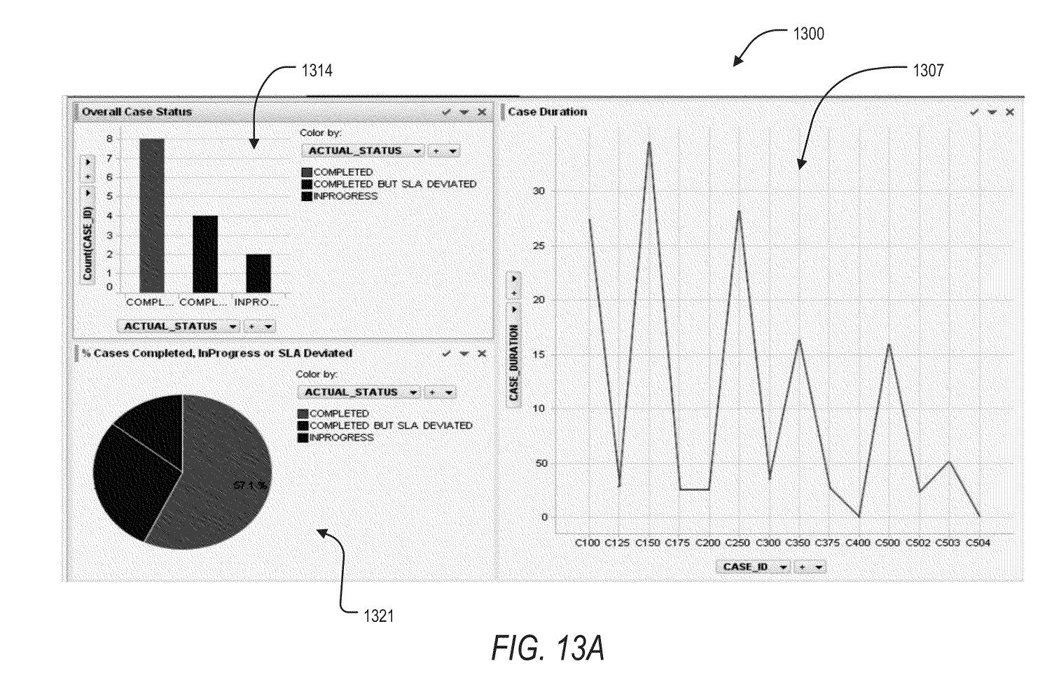

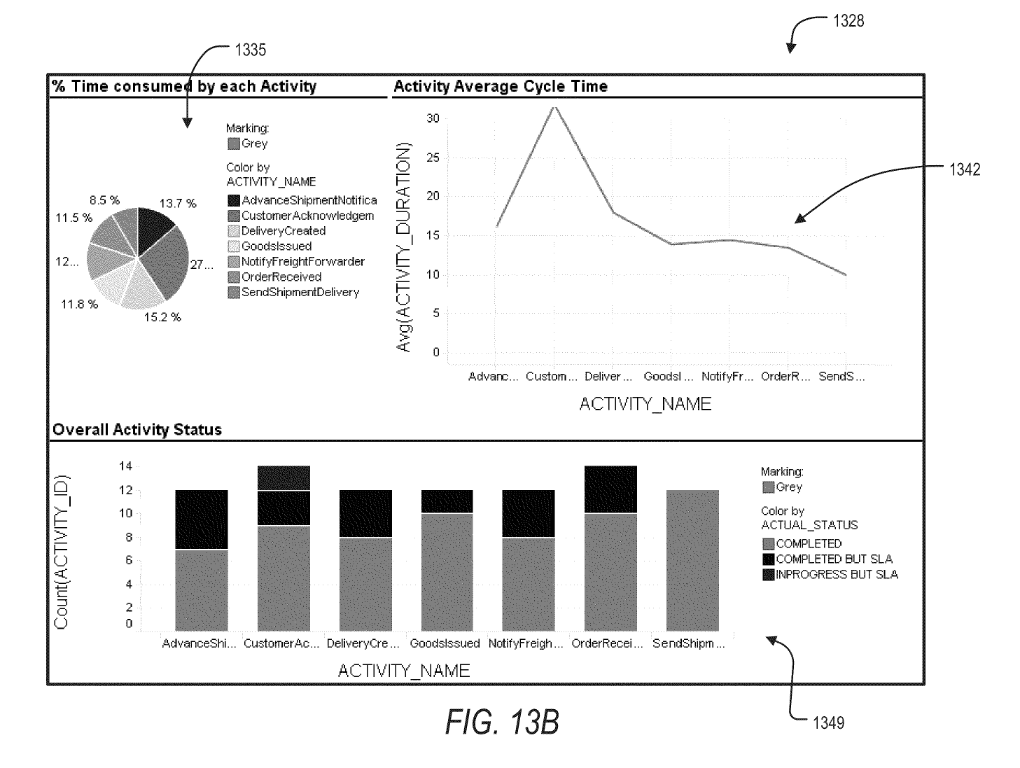

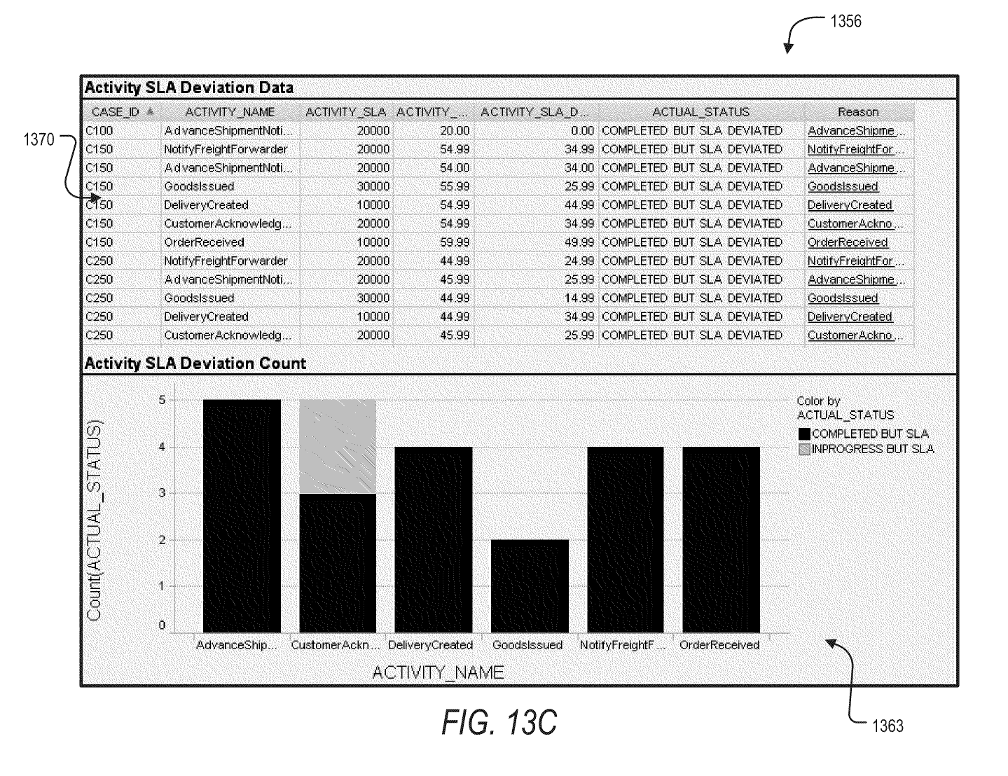

Such automatic configuration of the monitoring system 108 may effectively include automatically configuring the presentation layer 162, as particular charts, reports, and/or graphs on the process monitor dashboard 166 may be enabled by automatically configuring the case data store(s) 158 and/or the monitoring layer 126 to monitor the particular process activities comprising the business process. In this example embodiment, the presentation layer 162 comprises standard KPIs that are applicable to any business process, such as the time taken for completion of each process activity, completion time of the end-to-end process, SLA violations per activity, etc. The dashboard 166 may have a default setting in which absolute and relative values for the business process as a whole and for respective process activities are displayed in tables, charts, and/or graphs. At least some standard charts and/or reports may thus be provided without requiring any user customization, so that the standard charts and/or reports are enabled by automatic configuration of the monitoring layer 126 and the case data persistence layer 154. Examples of such dashboards 166 are described further below with reference to FIGS. 12-13.

In some embodiments, the user 124 may define additional KPIs during initial provision of structured business process model information to the monitoring configuration system 104, and the presentation layer 162 may automatically be configured to display information regarding the user-specified additional KPIs. In some instances, the user 124 may also define custom reports, charts, and/or dashboard displays, and the method 900 in such cases includes automatic configuration of the presentation layer 162 based on such user input.

The configuration of the monitoring system, according to method 910, may be repeated or refined when changes to the business process are implemented. If, for example, the business process is changed to include additional activities, to introduce new activities, or to change the sequence of activities, the monitoring system 108 may automatically be reconfigured by the configuration system 104 upon provision of updated business process model information to the configuration system 104. The various monitoring components generated by the monitoring component generator 116 reflect changes to the business process, and reconfigures the monitoring system 108 to monitor the altered business process. Because the rules 130 and/or state definitions 128 are not hand coded, process changes do not need any hand-code changes. Instead, the monitoring component generator 116 simply recompiles and redeploys the rules 130 and/or state definitions 128.

After automatic configuration of the process monitoring system 108, at operation 931, performance of the business process is monitored in real-time, in method 920, with respect to multiple cases of the business process. As previously described with reference to FIGS. 1 and 2, monitoring of the business process may comprise continually or continuously receiving, at operation 934, application event information at the application events correlation layer 142 from the application layer 146 (see FIG. 1). Application events indicated by the application event information may be mapped at the application events correlation layer 142 to the common event schema, at operation 937, to identify business events indicated by the underlying application events, and resulting business event information may be transmitted from the application events correlation layer 142 to the monitoring layer 126.

At the monitoring layer 126, the business events indicated by the received business event information may be applied to the state definitions 128, at operation 941, to identify current progress of respective cases along the defined business process, and/or to identify which of a plurality of alternative decision paths were followed or are being followed in individual cases. In some embodiments, decision path tracking is performed only with respect to business processes which, unlike the process 1000, include one or more decision points.

The method 900 further includes identifying process failure, at operation 949, based on the business event information received by the monitoring layer 126 and applied to the state definitions 128 based on the monitoring rules 130. Process failure may, for example, comprise SLA violations for individual process activities, or for the process 1000 as a whole. Process failures may further comprise nonperformance of a process activity that should have been performed within a specified or predefined time after competition of a preceding activity, as reflected in the monitoring rules 130. Process failures may also be identified responsive to malperformance of a particular business activity, or to execution of an incorrect decision path in a process having alternative paths.

In this example, identification of a process failure, at operation 949, automatically results in the generation of a process incident ticket, operation 953. The process incident ticket may automatically be transmitted to the MoM 170 (see for example FIG. 2). In this example, the MoM 170 submits the process incident ticket to the ticketing system 221 in a manner similar to the submission of IT system incidents. In other embodiments, the process monitoring module(s) 225 may directly transmit process incident tickets directly to the ticketing system 221. The example automatically generated segment of code that comprises rule 1110 of FIG. 11B is an example embodiment of an automatically generated monitoring component to cause generation and transmission of a process incident ticket responsive to nonperformance of a particular process activity.

Case and performance data that are filtered and/or generated by the monitoring layer 126 are transmitted and stored, at operation 945, to the case data store(s) 158. Because the case data store(s) 158 and the monitoring layer 126 are configured by the configuration system 104 based on common business process information, the tables, dimensions, facts, and data fields of the case data store(s) 158 correspond to the format and data fields of the case information transmitted to the case data store(s) 158 by the monitoring layer 126. Processed status reports for display in the dashboard 166 may thereafter be generated by the presentation layer 162 based on the case and/or performance data stored in the case data store(s) 158, at operation 947. Example dashboard displays for the process 1000 are described in greater detail with reference to FIGS. 12-13 below.

Returning for the moment to FIG. 9, the method 900 may also include monitoring the enterprise applications and infrastructure, at operation 957, for example by using application monitoring agents 211.n and the infrastructure monitoring agents 207.n, respectively. Monitoring of the enterprise applications 112.n and the infrastructure, in operation 957, may instead, or in addition, include monitoring by conventional IT element monitoring methods, such as, for example a resident network configuration management system that includes generation and monitoring of log files, SNMP traps, and the like. Responsive to the identification of IT system failures, at operation 961, IT incident tickets may automatically be generated and filed, at operation 965. The IT incident tickets may be communicated to the MoM 170 and/or to the ticketing system 221 (see FIG. 2).

The method 900 may thereafter comprise correlating process failures with IT system failures, by analyzing the process incident tickets and IT incident tickets received by the common ticketing system 221. Correlation of the process failures with the IT system failures, at operation 969, may be performed with reference to enterprise architecture information provided to the failure correlation engine 178 (see for example FIGS. 1 and 5) during configuration of the monitoring system 108 by the monitoring component generator 116. Instead, or in addition, identification of failure correlations may include accessing and investigating the CMDB 215 and/or applications, enterprise database(s) 426 or other IT system elements forming part of the enterprise architecture 650. Failure correlations may be identified based on a number of factors, such as proximity in time of IT incidents and the process incidents, a common activity with which both the IT system element indicated by the IT incident and the process failure are associated, etc.

For example, when the structured business process information, or investigation of the CMDB 215, indicates that a particular process activity is performed by an enterprise application 112.n executed on a particular process server 442.n, then more or less simultaneous or time-related incidents with respect to the particular activity and the particular process server 442.n may be correlated. The sequence of incidents may, of course, be taken into account in identifying failure correlations, since IT failures that cause process failures are expected to precede the process failures.

The data gathering and monitoring activities, including failure correlation and automatic updating of the dashboard display may be performed on an ongoing or continuous basis. The monitoring of the business process by the monitoring system 108 may thus be dynamic and the results may be gathered and displayed in real time. While there may be a lag between the performance of process activities and reflection of such performance in the monitored data, such monitoring is still considered to be performed “substantially in real time,” since, on the one hand, the application and business event information is “pushed” from lower layers to the case data store(s) 158, or since, on the other hand, the lag between performance of activities and recording thereof in the case data store(s) 158 is, on an ongoing basis, measurable in hours or minutes, rather than in business days.

Failure correlation information may be displayed, at operation 973, to an operator on an interactive user interface forming part of the presentation layer 162. Such display of failure correlations may be provided in an incident resolution application, or in any other suitable application or user interface. FIG. 12 shows an example embodiment of a graphic user interface (GUI) 1200 generated as part of an incident resolution application provided in the presentation layer 162 and communicating with the failure correlation engine 178. The example GUI 1200 includes an incident listing pane in which process incidents and IT incidents are listed together. In this example, the feature list of incidents includes: a process incident 1209 indicating that a process activity SLA was violated in a particular case or instance of the business process; a first IT incident 1218 associated with the breaching of a memory utilization threshold of a particular computing device forming part of the IT system 440; and a second IT incident 1227 indicating the breach of a CPU utilization threshold at the same device. When a user selects the process incident 1209 in the list pane, additional details 1236 of the process incident 1209 are displayed. The information displayed with respect to the process incident 1209 includes other incidents that were identified by the failure correlation engine 178 as being related to the selected process incident 1209. In the example GUI 1200 of FIG. 12, it is shown that both the first IT incident 1218 and the second IT incident 1227 are related to the process incident 1209.

FIGS. 13A-13C show respective example dashboard displays helium that may be generated with reference to the example process 1000 (as detailed in FIG. 10). The dashboard 1300 of FIG. 13A comprises a series of standard charts indicating performance data with respect to performance of the process 1000 as a whole. A bar chart 1314 indicates the quantities of cases that are completed, that are in progress, and that are completed with an SLA deviation, respectively. The dashboard 1300 further includes a pie chart 1321 showing the relative values of the above-mentioned performance indicators. In this example, 57% of the monitored cases are completed, 14.3% are in progress, and 28.6% are completed with SLA deviations. A line graph 1307 is further provided that shows the end-to-and duration of respective cases (listed on the x-axis).

FIG. 13B shows another dashboard 1328 that shows activity-level performance data for the monitored business process 1000. Pie chart 1335 shows the relative time consumed by each activity in the process 1000, while line graph 1342 shows average completion time for each process activity. The dashboard 1328 further includes a stacked bar chart 1349 that shows, for each activity, the number of cases or process instances that are completed, the number of cases that are completed with SLA violations/deviations, and the number of cases that are in progress with an SLA deviation.

Finally, FIG. 13C shows an example embodiment of a display 1356 with respect to process failure information. The display 1356 includes a list 1370 of SLA violations, and a stacked bar chart 1363 showing the number of cases completed with SLA deviations and the number of cases in progress with SLA deviations, for each activity of the process 1000. The list 1370 may be used in a failure correlation process (as described elsewhere) to retrieve, for example, relevant enterprise architecture information from, e.g., the CMDB 215.

The process monitor dashboard 166 as described above may be dynamic, in that the information displayed in the respective charts, graphs, and lists may be updated continually, in substantially real-time, responsive to the ongoing gathering of new process performance information, to provide in-flight process performance metrics and formation.

Well-established BAM tools focus on domain-specific process monitoring and also predicate that the business process should be automated in order to be monitored effectively. As can be seen with reference to the above-described example embodiments, this disclosure provides systems and methods that enable business activity monitoring in non-automated business processes, and may be effective in enterprises having no integrated business process management system. The monitoring of business activities are furthermore not domain-specific, and may include monitoring business activity performed by enterprise applications that span business domains, so that some of the monitored enterprise applications may be in one business domain and other monitored enterprise applications be in another business domain. In other words, the systems and methods disclosed herein enable business activity monitoring with respect to enterprise applications that are under the control and/or ownership of different corporate entities.

For example, the freight application 112.5 in the process 1000 of FIG. 10 is under the control and ownership of a freight forwarding company which is a different corporate entity from the business owners of the ordering application 112.2, the inventory application 112.3, and the stores application 112.4. Implementation of the process monitoring system 108 is therefore not domain specific, as it covers both the domain of enterprise applications 112.2-4 and the domain of freight application 112.5.

A further benefit of the systems and methods disclosed herein is that they may enable the prediction and monitoring of the process path that a particular case follows at runtime, in instances where the process model includes a decision element where several possible paths exist after the decision point.

The example systems and methods may also beneficially monitor events that include business events and IT events. Prior business activity monitoring systems often address only business events, and are therefore unable to reflect functional dependence of the business events on underlying IT system elements. This disclosure, however, recognizes the importance of IT events to the business process and incorporates the monitoring of IT events in the monitoring of business activity.

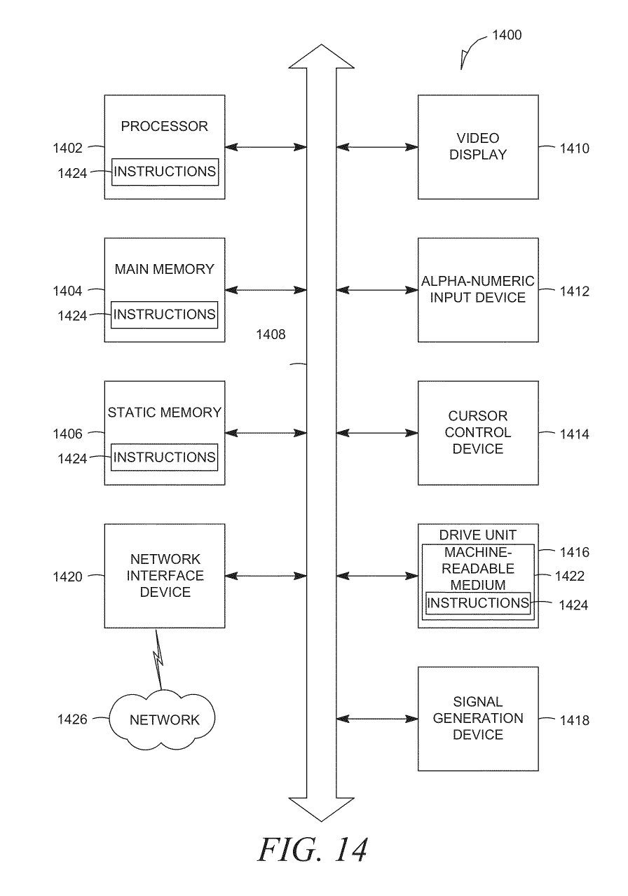

FIG. 14 shows a diagrammatic representation of machine in the example form of a computer system 1400 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU) a graphics processing unit (GPU) or both), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard), a cursor control device 1414 (e.g., a mouse), a disk drive unit 1416, a signal generation device 1418 (e.g., a speaker) and a network interface device 1420.

The disk drive unit 1416 includes a machine-readable medium 1422 on which is stored one or more sets of instructions (e.g., software 1424) embodying any one or more of the methodologies or functions described herein. The software 1424 may also reside, completely or at least partially, within the main memory 1404 and/or within the processor 1402 during execution thereof by the computer system 1400, the main memory 1404 and the processor 1402 also constituting machine-readable media.

The software 1424 may further be transmitted or received over a network 1426 via the network interface device 1420.

While the machine-readable medium 1422 is shown in an example embodiment to be a single medium, the term “machine-readable medium” should be taken to include a single medium or multiple media (e.g., a centralized or distributed database, and/or associated caches and servers) that store the one or more sets of instructions 1424. The term “machine-readable medium” shall also be taken to include any medium that is capable of storing, encoding or carrying a set of instructions for execution by the machine and that cause the machine to perform any one or more of the methodologies of the embodiments of this disclosure. The term “machine-readable medium” shall accordingly be taken to include, but not be limited to, solid-state memories, optical and magnetic media, and carrier wave signals.

### Modules, Components, and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

Therefore, in the above-described example systems and methods, various embodiments may be realized, including a method that comprises: accessing structured business process information that defines a business process comprising a plurality of process activities; and, using one or more processors, automatically generating one or more monitoring components, based at least in part on the business process information, the one or more monitoring components being configured to form part of a monitoring system to automatically monitor events with respect to a plurality of unmanaged enterprise applications that perform at least one of the process activities without central orchestration by a business process management application. The method and system must may thus provide automated generation of a business activity monitoring solution in the absence of a business process management solution.

In some embodiments, the structured business process information may comprise a process model that defines a series of activities. Instead, or in addition, the structured business process information may comprise a state machine module that, for example, defines a series of states that instances of the business process may have.

Note that central orchestration by a business process management application comprises more than the monitoring or gathering of information by a management application and may include at least some control by the central business management application over respective enterprise applications, and/or or integrated design and implementation of the business management application and the enterprise applications.

A system may be provided that includes a process information module to access the structured business process information, and a monitoring component generator to automatically generate the monitoring components.

As used herein, the term “process” means not only an end-to-end business process, but may also refer to a constituent part of a business process that comprises two or more activities (such as a sub-process or a group of sub-processes), or a collection or group of processes.

The one or more monitoring components may comprise process monitoring rules to be employed by a monitoring layer that may form part of the monitoring system. The monitoring layer may receive event information with respect to events at the plurality of unmanaged enterprise applications. The method may further comprise incorporating the monitoring rules in the monitoring layer. To this end, the system may include a rules compiler and a deployment module. The monitoring layer may comprise a central monitoring layer, by which is meant that the monitoring layer is located between an enterprise layer or application layer and a presentation layer in an information flow chain, and does not mean that the monitoring layer is necessarily located in a central geographical location, or that the central monitoring layer is necessarily centralized in a single application.

The process monitoring rules may include rules to identify nonperformance by associated unmanaged enterprise applications of respective process activities in individual instances of the process. The rules compiler may thus be configured to automatically generate nonperformance rules to identify nonperformance of process activities based on the structure of process information. The process monitoring system may further comprise one or more process monitoring module(s) to monitor performance of the business process and to identify nonperformance of expected process activities (based, e.g., on a process model) in individual instances of the business process.

The process monitoring module may be configured to generate rules and/or state definitions with which the monitoring layer of the process monitoring system may be configured to aggregate, analyze, and/or filter business event information received by the monitoring layer from the plurality of unmanaged enterprise applications. The process monitoring layer may thus be operable to receive the business event information and to correlate individual business events to respective process activities in individual instances of the business process.

The monitoring system may include an application event correlation layer to receive application event information from the unmanaged enterprise applications, to map the application event information to underlying business events associated with generation of the application event information, and to provide the business event information to the monitoring layer. To this end, the monitoring system may include a common event schema, e.g., having standard name value pairs. The monitoring system may in such embodiments include a schema mapping module, for example employed in the application event correlation layer, to map source event schemas (in the example form of application event schemas) to the common event schema. The application event correlation layer thus provides the monitoring layer with business event information in the common event schema.

The one or more monitoring components may comprise monitoring agents configured to monitor the occurrence of events at the plurality of unmanaged enterprise applications, and to report occurrence of the events to a monitoring layer forming part of the monitoring system, the method further comprising deploying the monitoring agents to respective IT system elements. In some embodiments, the monitoring agents may be application monitoring agents that are deployed to respective unmanaged enterprise applications to monitor and report application events occurring at the associated unmanaged enterprise applications.

Instead, or in addition, the monitoring agents may include one or more infrastructure monitoring agents that are deployed to respective information technology (IT) system infrastructure elements to automatically monitor and report IT events occurring at the associated IT system infrastructure elements.

The method may include automatically configuring a process monitoring database forming part of the monitoring system, based at least in part on the business process information. Such configuration of the process monitoring database may comprise automatic generation of database elements of the process monitoring database. The process monitoring database may thus be configured to store process performance information generated by the monitoring system during the monitoring of performance of respective instances of the business process. The process performance information may comprise case data regarding respective cases or instances of the process. The process performance information may instead, or in addition, include performance indicators and performance statistics for multiple instances of the business process, such as KPIs and/or SLA compliance information and/or statistics. The database elements may, for example, include one or more fact tables that define database facts with respect to the business process and/or the respective process activities.

In some embodiments, the system may include the monitoring system. The method may thus further comprise monitoring performance of the business process, the monitoring including receiving, at the monitoring layer, event information with respect to the plurality of unmanaged enterprise applications.

The event information received at the monitoring layer may include business event information with respect to business events associated with performance of the respective activities by the plurality of unmanaged enterprise applications. The method may further comprise providing an application event correlation layer to receive from the plurality of unmanaged enterprise applications application event information indicative of application events, to identify the business events underlying the application event information by mapping the application event information to business events based on a common event schema, and to provide the business event information to the monitoring layer.

The method may further comprise receiving automatically generated IT event information with respect to IT events occurring at associated IT system infrastructure elements, and correlating the IT events indicated by the IT event information with one or more associated process failures, thereby identifying potential associations between IT events, such as IT failures, and process failures. The method may further include generating failure reports displayed on a user endpoint device to inform a user about potential correlation between at least one process failure and an associated IT event. Correlation of the IT events to the one or more process failures may comprise correlating an infrastructure failure to one or more of an enterprise application failure, a data failure, and a business process failure. Failure correlation may comprise accessing or parsing enterprise architecture information and/or process repository information, to identify links and/or associations between process activities and infrastructure elements.

The system may include a common ticketing system to receive and process incident tickets with respect to, on the one hand, process incidents indicative of malperformance or nonperformance of respective instances of the business process or business process activities, and, on the other hand, incident tickets with respect to one or more of IT infrastructure failures, enterprise application failures, and/or data failures.

A method and system may be provided to perform business activity monitoring that includes correlating process failure information and IT failure information, to identify potential causal relationships between IT failures and associated process failures. In some embodiments, such automatic process failure correlation to underlying IT system causes may be provided in a system and method that does not provide automated generation of process monitoring components, as described with reference to some aspects of this disclosure. Such a method and system may include the elements and features disclosed herein related to enabling and/or facilitating IT- and process-failure correlation. Process failure information may thus include process incident information (e.g., indicated by process incident tickets generated responsive to identification of process failures and/or incidents), while IT failure information may include IT incident information (e.g., indicated by IT incident tickets generated responsive to identification of IT system failures and/or incidents).

In accordance with another embodiment, there is provided a method that comprises: receiving structured business process information that indicates a plurality of process activities forming part of a business process; parsing the business process information; and automatically configuring a process monitoring system based on the structured business process information, to automatically monitor performance of the plurality of process activities by one or more unorchestrated enterprise applications.

Thus, a system and method to monitor a business process is described, as well as a system and method to configure a process monitoring system. Although these methods and systems have been described with reference to specific example embodiments, it will be evident that various modifications and changes may be made to these embodiments without departing from the broader spirit and scope thereof. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing structured business process information that defines a business process comprising a plurality of process activities; and
using one or more processors, automatically generating one or more monitoring components, based at least in part on the business process information, the one or more monitoring components being configured to form part of a monitoring system to automatically monitor events with respect to a plurality of unmanaged enterprise applications that perform at least some of the process activities without central orchestration.

2. The method of claim 1, wherein the one or more monitoring components comprise process monitoring rules to be employed by a monitoring layer that forms part of the monitoring system and that receives event information with respect to events at the plurality of unmanaged enterprise applications, the method further comprising incorporating the process monitoring rules in the monitoring layer.

3. The method of claim 2, wherein the process monitoring rules include rules to identify nonperformance by associated unmanaged enterprise applications of process activities within respective stipulated time limits after respective preceding activities in individual instances of the business process.

4. The method of claim 2, wherein the process monitoring rules include rules to compare performance of parallel process paths, and to identify frequent performance of a particular process path instead of a more cost-effective alternative path.

5. The method of claim 1, wherein the one or more monitoring components comprise monitoring agents configured to monitor occurrence of events at the plurality of unmanaged enterprise applications, and to report occurrence of the events to a monitoring layer forming part of the monitoring system, the method further comprising deploying the monitoring agents to respective information technology (IT) system elements.

6. The method of claim 5, wherein the monitoring agents include one or more infrastructure monitoring agents that are deployed to respective information technology (IT) system infrastructure elements to automatically monitor and report IT events occurring at the associated IT system infrastructure elements.

7. The method of claim 6, further comprising performing automated determination of association between IT system infrastructure elements and process activities, the infrastructure monitoring agents being generated automatically based at least in part on the automatically determined associations.

8. The method of claim 1, further comprising monitoring performance of the business process, the monitoring including receiving, at a monitoring layer, event information with respect to events at the plurality of unmanaged enterprise applications.

9. The method of claim 8, further comprising:
receiving, at an application event correlation layer, application event information regarding respective application events from the plurality of unmanaged enterprise applications;
mapping the application events to a common event schema to identify respective business events associated with the application events; and
providing business event information indicating the identified business events to the monitoring layer.

10. The method of claim 8, further comprising:
receiving IT event information automatically generated with respect to information technology (IT) events occurring at associated IT system infrastructure elements; and
correlating the IT events indicated by the IT event information with one or more process failures, to identify potential associations between IT events and process failures.

11. The method of claim 10, wherein the correlating of the IT events to the one or more process failures comprises correlating an infrastructure failure to one or more of an enterprise application failure, a data failure, and a business process failure.

12. The method of claim 11, further comprising generating on a user interface device a visual display that shows the IT events overlaid over a schematic representation of the business process.

13. The method of claim 10, further comprising:
responsive to identification of a process failure in an instance of the business process, generating a process incident ticket and submitting the process incident ticket to a ticketing system; and
responsive to identification of an IT system failure, generating an IT event ticket and submitting the IT event ticket to the ticketing system, the ticketing system being a common ticketing system for process incident tickets and IT events tickets.

14. A method comprising:
receiving process incident information with respect to process incidents in a business process that comprises a plurality of process activities;
receiving IT incident information with respect to information technology (IT) incidents in an IT system by which the business process is, at least in part, performed; and
using one or more processors, automatically correlating a particular process incident with one or more IT incidents, to identify a potential causal link between the one or more IT incident and the particular process incident.

15. The method of claim 10, wherein the correlating comprises correlating an infrastructure failure indicated by the one or more IT incidents to one or more of an enterprise application failure, a data failure, and a business process failure.

16. The method of claim 10, wherein the correlating is performed on an ongoing basis, at or near real-time relative to real-world performance of the business process.

17. A system comprising:
a process information module to access structured business process information that defines a business process comprising a plurality of process activities; and
a monitoring component generator to automatically generate one or more monitoring components, based at least in part on the business process information, the one or more monitoring components being configured to form part of a monitoring system to automatically monitor events with respect to a plurality of unmanaged enterprise applications that perform at least one of the process activities without central orchestration by a business process management application.

18. The system of claim 17, wherein the monitoring component generator includes a rules compiler to generate process monitoring rules to be employed by a monitoring layer that forms part of the monitoring system and that receives event information with respect to the plurality of unmanaged enterprise applications, the system further comprising a deployment module to incorporate the process monitoring rules in the monitoring layer.

19. The system of claim 18, wherein the rules compiler is configured to generate process monitoring rules that include rules to identify nonperformance by associated unmanaged enterprise applications of respective process activities within a stipulated time limit after the previous activities in individual instances of the business process.

20. The system of claim 17, wherein the monitoring component generator includes a monitoring agent generator to generate one or more monitoring agents that are configured to monitor occurrence of events at the plurality of unmanaged enterprise applications, and to report occurrence of the events to a monitoring layer forming part of the monitoring system.

21. The system of claim 20, wherein the monitoring agents include one or more infrastructure monitoring agents that are configured to be deployed to respective information technology (IT) system infrastructure elements to automatically monitor and report IT events occurring at the associated IT system infrastructure elements.

22. The system of claim 17, wherein the monitoring component generator includes a database engine to automatically generate database elements of a process monitoring database that is to store process performance information generated by the monitoring system during monitoring of performance of respective instances of the business process.

23. The system of claim 22, wherein the database engine is configured to generate one or more fact tables with respect to the business process and/or the respective process activities.

24. The system of claim 17, further comprising one or more process monitoring modules to monitor performance of the business process, the one or more process monitoring modules being configured to implement a monitoring layer at which event information with respect to the plurality of unmanaged enterprise applications is received.

25. The system of claim 24, wherein the one or more process monitoring modules include a process path module to identify which of a plurality of alternative process paths are to be followed in respective process instances at one or more decision points of the business process.

26. The system of claim 24, further comprising a failure correlation engine to receive automatically generated IT event information with respect to IT events occurring at associated IT system infrastructure elements, and to correlate IT events indicated by the IT event information with one or more process failures, thereby identifying potential associations between IT events and process failures.

27. The system of claim 24, further comprising a process ticket module to generate a process incident ticket responsive to receiving an indication of a process failure, and to submit the process incident ticket to a common ticketing system that also receives and processes incident tickets with respect to one or more of IT infrastructure failures, enterprise application failures, or data failures.

28. A system comprising:
a ticketing system to receive process incident information with respect to process incidents in a business process that comprises a plurality of process activities, and IT incident information with respect to information technology (IT) incidents in an IT system by which the business process is, at least in part, performed; and
a failure correlation to automatically correlate a particular process incident with one or more IT incidents, to identify a potential causal link between the one or more IT incident and the particular process incident.

29. The system of claim 28, further comprising a process ticket module to generate process incident information in the form of process incident tickets responsive to observance of respective process failures and to communicate the process incident tickets and to the ticketing system.

30. A non-transitory machine-readable storage medium storing instructions which, when performed by a machine, cause the machine to:
access structured business process information that defines a business process comprising a plurality of process activities; and
automatically generate one or more monitoring components, based at least in part on the business process information, the one or more monitoring components being configured to form part of a monitoring system to automatically monitor events with respect to a plurality of unmanaged enterprise applications that perform at least one of the process activities without central orchestration by a business process management application.

31. A system comprising:
means for dynamically accessing structured business process information that defines a business process comprising a plurality of process activities; and
means for automatically generating one or more monitoring components, based at least in part on the business process information, the one or more monitoring components being configured to form part of a monitoring system to automatically monitor events with respect to a plurality of unmanaged enterprise applications that perform at least one of the process activities without central orchestration by a business process management application.
